(19) United States
(12) Patent Application Publication
(10) Pub. No.: US 2024/0175790 A1
(43) Pub. Date: May 30, 2024

(54) EXPANDED VACUUM-STABLE GELS FOR MULTIPLEXED HIGH RESOLUTION SPATIAL HISTOPATHOLOGY

(71) Applicant: The Board of Trustees of the Leland Stanford Junior University, Stanford, CA (US)

(72) Inventors: Garry P. Nolan, Redwood City, CA (US); Yunhao Bai, Stanford, CA (US); Bokai Zhu, Redwood City, CA (US); Xavier Rovira Clave, Redwood City, CA (US); Sizun Jiang, Redwood City, CA (US)

(21) Appl. No.: 18/196,402

(22) Filed: May 11, 2023

Related U.S. Application Data
(60) Provisional application No. 63/341,327, filed on May 12, 2022.

(51) Int. Cl. G01N 1/30

(52) U.S. Cl. CPC G01N 1/30

(57) ABSTRACT

Provided herein is a method for processing a tissue sample. The method may comprise: (a) permeating the tissue section with monomers for a negatively charged expandible gel, (b) allowing the monomers to polymerize in the tissue sample, (c) hydrating the tissue sample, thereby causing the sample to expand, (d) adhering expanded tissue sample to a positively charged surface and (e) dehydrating the expanded tissue sample while it is on the planar surface.

### CROSS-REFERENCING

This application claims the benefit of 63/341,327, filed on May 12, 2022, which application is incorporated by reference herein.

### GOVERNMENT SUPPORT

This invention was made with Government support under contract 75F40120C00176 awarded by the Food and Drug Administration and under contract HHSF223201610018C awarded by the Food and Drug Administration. The Government has certain rights in the invention.

### BACKGROUND

Microenvironments both within and around cells can determine cellular identity, function, and fate. Fluorescence microscopy is the de facto choice for biomolecular imaging at the mesoscale, but despite remarkable utilities, it continues to be hindered by physical constraints including the diffraction limit of light, fluorophore spectral overlap, and tissue autofluorescence. Overcoming these limitations will enable new frameworks to contextualize distinct biomolecules and their associated functions at the mesoscale, within their natural environments.

Super-resolution microscopy methods circumvent the diffraction limit of light (Hell 1994, Betzig 2006, Rust 2006), but, unlike conventional fluorescence microscopy, these methods require highly specialized chemical probes, microscopy equipment, and experimental conditions. An alternative approach aimed at democratizing super-resolution imaging is to physically enlarge the sample, rather than improving instrumentation capabilities. Boyden and colleagues pioneered this concept, termed Expansion Microscopy (ExM) (Chen et al., 2015; Tillberg et al., 2016). In ExM, an acrylate-based polymer mesh is interlaced into biological specimens prior to physical expansion induced by replacement of high salt buffer with water. The initial approach enabled an approximate 4-fold expansion in the lateral and axial directions while diminishing autofluorescence (Chen et al., 2015). Modifications of the original polymer chemistry enabled even larger fold expansions (Chang 2017, Truckenbrodt 2018, Truckenbrodt 2019, Damstra 2022), multiplexed whole organ imaging (Ku et al., 2016), analysis of formalin-fixed paraffin-embedded (FFPE) archival pathological specimens (Zhao et al., 2017), and of subcellular components (Gambarotto et al., 2019; Laporte et al., 2022).

Many current ExM-derived methods are dependent on fluorescence-based microscopy and thus share many of the same limitations. The most restrictive is the spectral overlap between fluorophores, which significantly limits multiplexing capabilities. Iterative multiplexing strategies, including CODEX (Goltsev et al., 2018; Schürch et al., 2020) and CycIF (Lin et al., 2015), are not easily compatible with ExM due to the chemical treatments involved in probe or antibody stripping. Although initial efforts towards multiplexed imaging within expanded tissues have been encouraging (Ku 2016, Wang 2018, Alon 2021), scalability remains a challenge.

Mass spectrometry imaging (MSI), an alternative to fluorescence-based multiplexed imaging that images mass-tagged or intrinsic biomolecules, is capable of simultaneous acquisition of tens to hundreds of parameters (Berry 2011, Steinhauser 2012, Rovira-Clavé 2021, Sun 2021). Recent technical breakthroughs have allowed antibody-based spatial proteomics analyses of tissues with MSI down to the single cell level, including two alternative tagging and visualization methods termed Multiplexed Ion Beam Imaging (MIBI) (Angelo et al., 2014; Keren et al., 2018, 2019) and Imaging Mass Cytometry (IMC) (Giesen et al., 2014). These platforms are well suited for studies into tissue organization, but limited in their ability to discern subcellular features. This is due to a limited imaging resolution, which is directly related to the spot size of the ion beam or laser (approximately 400 nm for MIBI and 1000 nm for the IMC). Additional chemical probes for High Definition MIBI (HD-MIBI) were recently developed for targeted MSI at even higher resolutions (Rovira-Clavé et al., 2021a). HD-MIBI can resolve targets at around 50 nm but is currently limited to eight detectable parameters and difficult to scale across large areas of tissue.

A physically expanded sample compatible with the high-vacuum or desiccated natures of the MIBI and IMC, respectively, would allow highly multiplexed imaging into the subcellular resolutions without costly instrumental development or new labeling chemistries. Given the abundance and accessibility of archival tissue samples, a desirable ExM-derived method should preserve protein epitopes to be compatible with high-plex antibody staining and imaging of these highly crosslinked samples. Previous ExM attempts in FFPE tissues required extensive proteolytic digestion after labeling to homogenize the tissue for uniform expansion (Zhao et al., 2017). This step is detrimental for preserving epitope antigenicity, as seen by lower antibody staining signals, which can impair high-plex protein-based staining and imaging (Tillberg and Chen, 2019). An alternative method, known as Magnified Analysis of Proteome (MAP) (Ku et al., 2016), uses a high concentration of monomers to reduce the intermolecular crosslink between proteins and promote their linkage to the polymer network through non-enzymatic denaturation, but is not compatible with FFPE tissue yet. Preservation of antigenicity is fundamental for the successful integration of ExM-related hydrogel methods with high-plex immunohistochemistry.

### SUMMARY

Provided herein is a method for processing a tissue sample. The method may comprise: (a) permeating the tissue sample with monomers for a negatively charged expandible gel, (b) allowing the monomers to polymerize in the tissue sample, (c) hydrating the tissue sample, thereby causing the sample to expand, (d) adhering expanded tissue sample to a positively charged surface and (e) dehydrating the expanded tissue sample while it is on the planar surface.

This method, which may be referred to as Expand and comPRESS hydrOgels (or “ExPRESSO”) in the description that follows below, may be used interrogate the proteome organization in physically expanded hydrogel-embedded tissues without proteolysis. ExPRESSO facilities the removal water molecules in the hydrogel while retaining the expanded lateral dimensions. The compatibility of these gels in the high vacuum chamber of the MIBIscope (down to 10-7 mBar) and under the desiccated condition required for the IMC platform was demonstrated, obtaining antibody-based imaging of 21 proteins at nearly 4 times the original resolution without instrument modifications. This optimized protocol retains tissue antigenicity and morphology for high resolution antibody-based spatial proteomics in the subcellular domain of archival tissues. Application of ExPRESSO in FFPE lymphoid and brain tissues validated previously known biomolecular and cellular structures, while revealing organizational features of the blood brain barrier (BBB) at unprecedented scale and resolution. ExPRESSO has the potential to be complementary to spatial-omic studies in addition to the standard light-based modalities, allowing a multi-dimensional understanding of how biomolecules, cells, and both subcellular and cellular neighborhoods are organized in health and disease.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The skilled artisan will understand that the drawings, described below, are for illustration purposes only. The drawings are not intended to limit the scope of the present teachings in any way.

FIGS. 1A-1H. The ExPRESSO workflow for multiplex tissue imaging at a 3.7× resolution. (1A) ExPRESSO workflow: (1) Archival tissues are sectioned, (2) reverse-crosslinked using heat-induced epitope retrieval with a PT module, (3) embedded into a hydrogel, and heated in a denaturing buffer. (4) The hydrogel-embedded tissues are stained with a cocktail of isotope-conjugated antibodies before (5) expansion and (6) collapse in a desiccated environment. ExPRESSO samples can then be analyzed using high-multiplexed mass spectrometry imaging methodologies such as MIBI or IMC. (1B) Representative images, and enlarged images, of a human hippocampus section after (I) sectioning of a representative 4-μm sample, (II) denaturing, (III) expanding, and (IV) collapsing onto gold and glass slides for MIBI (upper) and IMC (lower) analysis, respectively. Each grid is 2.5 mm long. Scale bars (all scale bars indicate physical measurements): 10 mm. (1C) Representative fluorescence images of a human hippocampus section stained with Hoechst 33342 before (left) and after collapsing (right). Enlarged images are shown at the bottom. Scale bars (all scale bars indicate physical measurements): 1 mm. (1D) Comparison of MIBI (left and middle) and ExPRESSO-MIBI (right) imaging in two consecutive adjacent sections of a human tonsil. Representative MIBI images include markers for T cells (CD3), B cells (CD20), B cells and follicular dendritic cells (CD21), structural intermediate filaments (Vimentin), cell proliferation (Ki-67), nuclear envelope (Lamin A/C), and nuclei (Histone H3). The middle image is an enlarged view of the image region on the left, and its size was matched with the right image. Further enlarged views are shown at the top left in the middle and right images. Scale bars (the ExPRESSO-MIBI scale bars indicate the pre-expansion dimensions based on a 3.7-fold expansion): 100 μm (main), 25 μm (middle and right, enlarged). (1E) Top: Expansion fold quantification, data are presented as four independent quantifications from four tissues for linear and area strategies and as means+/−standard deviation for segment strategy. Bottom: Schematic representation of quantification strategies: pre- and post-ExPRESSO tissues were compared using a linear strategy, by calculating the ratio of sizes of the longest possible line in the tissue and its perpendicular, and an area strategy, by calculating the ratio of the areas. MIBI images from unexpanded and ExPRESSO tonsil samples were segmented and the expansion fold was calculated using a segment strategy by comparing the size of the cell perimeter. (1F) Assessment of ExPRESSO samples after long-term storage. The same ExPRESSO tonsil sample was imaged by MIBI 1, 3 and 6 months after collapsing. Top: Total counts of Histone H3 and double-stranded DNA (dsDNA) from 5 fields of view (FOVs) at each timepoint. Bottom: Representative MIBI images at selected times. Scale bars (the ExPRESSO-MIBI scale bars indicate the pre-expansion dimensions based on a 3.7-fold expansion): 100 μm. (1G) MIBI measurement of Histone H3 and dsDNA counts (per pixel) in an ExPRESSO tonsil sample analyzed with a range of primary ion currents. (1H) Representative MIBI images of unexpanded and ExPRESSO-treated tonsil samples at a similar spatial resolution with an image cap of 300 counts per pixel. Values indicate counts (per pixel) at each condition. Scale bars (the ExPRESSO-MIBI scale bars indicate the pre-expansion dimensions based on a 3.7-fold expansion): 25 μm.

FIGS. 2A-2B. ExPRESSO is compatible with mass spectrometry-based highly multiplex imaging technologies. (2A) Comparison of MIBI (top) and ExPRESSO-MIBI (bottom) imaging of two sections of a human tonsil with markers for helper T cells (CD3 and CD4), cytotoxic T cells (CD3 and CD8), B cells (CD20 and Pax-5), B cells and follicular dendritic cells (CD21), antigen-presenting cells (HLA-DR), macrophages (CD68), structural intermediate filaments (Vimentin), proliferation (Ki-67), nuclear envelope (Lamin A/C), and nuclei (Histone H3). The four images on the right are enlarged views of the image on the left. Scale bars (the ExPRESSO-MIBI scale bars indicate the pre-expansion dimensions based on a 3.7-fold expansion): 50 μm (left), 10 μm (right). (2B) Comparison of IMC (left and middle) and ExPRESSO-IMC (right) imaging in two adjacent sections of a human tonsil with markers for T cells (CD3), B cells (CD20), B cells and follicular dendritic cells (CD21), structural intermediate filaments (Vimentin), proliferation (Ki-67), nuclear envelope (Lamin A/C), and nuclei (Histone H3). The middle image is an enlarged view of the image on the left, and its size was matched with the right image. Enlarged views are shown at the top left in the middle and right images. Scale bars (the ExPRESSO-IMC scale bars indicate the pre-expansion dimensions based on a 3.7-fold expansion): 100 μm (main), 25 μm (middle and right, enlarged).

FIGS. 3A-3D. ExPRESSO better resolves fine details of subcellular structures. (3A) Representative MIBI images for Lamin A/C (left), Vimentin (middle), and CD21 (left) in human tonsils. Line scans along the orange (MIBI) and cyan (ExPRESSO-MIBI) lines in the MIBI images. Raw ion counts (Y-axis) were plotted to each individual pixel (X-axis), and the ExPRESSO-MIBI lines were scaled down by expansion fold to match MIBI lines. Scale bars (the ExPRESSO-MIBI scale bars indicate the pre-expansion dimensions based on a 3.7-fold expansion): 25 μm. (3B and 3C) Comparison of MIBI (left) and ExPRESSO-MIBI (right) imaging in two adjacent sections of a human tonsil. ExPRESSO-MIBI resolves b) MPO puncta and c) Ki-67 and nucleolin compartmentalization. Scale bars (the ExPRESSO-MIBI scale bars indicate the pre-expansion dimensions based on a 3.7-fold expansion): 25 μm (main), 5 μm (enlarged). (3D) Comparison of cell segmentation performance in MIBI (left) and ExPRESSO-MIBI (right) imaging of a human tonsil. For each group, representative MIBI images on the left show the nuclei by Histone H3 staining, and images on the right depict a cell segmentation map together with nuclear staining (Histone H3). Orange arrows indicate regions with high nuclear signal that were not segmented as cells, and arrowheads point to doublets indicative of undersegmentation. Scale bars (the ExPRESSO-MIBI scale bars indicate the pre-expansion dimensions based on a 3.7-fold expansion): 25 μm (main), 5 μm (enlarged).

FIGS. 4A-4C. ExPRESSO enables multiplexed proteomic assessment of archival human brain sections at subcellular resolution. (4A) MIBI imaging of an ExPRESSO-processed human brain tissue section from the middle frontal gyrus. Top: Representative linear acquisition of 16 FOVs, each one with a size of 400×400 μm (physical measurements). Images include markers for neurons (MAP2), vessel lumen and BBB leakiness (Albumin), astrocytes (GFAP and GlnSyn), vessels (GLUT1), microglia (Iba1), and nuclei (Histone H3). Bottom: Enlarged views of the gray matter (left; GFAP and GlnSyn high) and white matter (right; GFAP and GlnSyn low). Scale bars (the ExPRESSO-MIBI scale bars indicate the pre-expansion dimensions based on a 3.7-fold expansion): 50 μm. (4B) MIBI imaging of an ExPRESSO-processed human hippocampus tissue section. Middle: Representative tile acquisition of 9 FOVs, each one with a size of 400×400 μm (physical measurements). Images include markers for pre-synapse (Synaptophysin), astrocyte projections (GFAP), nuclei (Histone H3), microglia (Iba1), vessel lumen and BBB leakiness (Fibrinogen), vessels (GLUT1), muscularized vasculature (SMA). Left and right: Enlarged views of the blood brain barrier (BBB). The BBB images at the top include the markers in the middle image and the BBB images at the bottom include markers for basement membrane (Collagen IV), endothelial cells (CD105 (Endoglin), and vWF), astrocytes (GFAP), neurons (MAP2), pre-synapse (VAMP2), and neurons with oxidative stress (8OHG). Scale bars (the ExPRESSO-MIBI scale bars indicate the pre-expansion dimensions based on a 3.7-fold expansion): 50 μm (middle) and 10 μm (left and right). (4C) Representative MIBI images of cellular and non-nuclear components in the human brain including microglia, vessels, astrocytes, and BBB. Vessels are observed as transversal (top) and longitudinal (bottom) sections. Scale bars (the ExPRESSO-MIBI scale bars indicate the pre-expansion dimensions based on a 3.7-fold expansion): 25 μm.

FIGS. 5A-5C. ExPRESSO enables enhanced interrogation of cells and non-nuclear features, including the BBB, in archival human brain sections. (5A) MIBI imaging of an ExPRESSO-processed human hippocampus tissue section (top) and middle frontal gyrus (bottom) with tile acquisition of 9 FOVs, each one with a size of 400×400 μm (physical measurements). Shown are markers for pre-synapse (Synaptophysin), astrocyte projections (GFAP), nuclei (Histone H3), microglia (Iba1), vessel lumen and BBB leakiness (Fibrinogen or Albumin or SAA and Fibrinogen), vessels (GLUT1), muscularized vasculature (SMA), basement membrane (Collagen IV), endothelial cells (CD105 and vWF), astrocytes (GlnSyn or GFAP), neurons (MAP2), pre-synapse (VAMP2 or Synaptophysin), neurons with oxidative stress (8OHG), myelin and oligodendrocytes (MAG). Enlarged views of boxed areas are shown as insets. Scale bars (the ExPRESSO-MIBI scale bars indicate the pre-expansion dimensions based on a 3.7-fold expansion): 100 μm (main) and 20 μm (enlarged). (5B) Anchoring analysis around vessel feature segment components on both MIBI samples (left) and ExPRESSO-MIBI gels (right) in both curve and heatmap. The average counts were plotted as solid lines, while the 95% confidence intervals were plotted as shadow around lines. The heatmap of ExPRESSO-MIBI is labeled with blue bars to indicate the local maximum of the respective channel in the ExPRESSO gel analysis. (5C) Left: Schematic of components of the BBB and markers used for their identification in the ExPRESSO-MIBI brain panel. Middle and right: Representative complex of BBB, enlarged view from a region in FIG. 5A, and bicolor enlarged regions to further show details. Scale bars (the ExPRESSO-MIBI scale bars indicate the pre-expansion dimensions based on a 3.7-fold expansion): 250 μm (middle) and 10 μm (right, enlarged).

FIGS. 6A-6G. Validation of the ExPRESSO workflow. (6A) Schematic representation of two expansion approaches for protein detection. Top: The pro-ExM and ExPath frameworks first stain targeted proteins with antibodies, and then use a reagent (e.g., acryloyl-X or AcX) to anchor sample proteins and antibodies to the in situ polymerized gel network. Samples are then proteolytically digested and expanded. Bottom: The ExPRESSO process, inspired by MAP, first anchors sample proteins to an in situ polymerized gel network using a high concentration of acrylamide and then dissociates biomolecular complexes in the sample by a heat and SDS co-treatment. Samples are then stained with antibodies and expanded. (6B) Representative fluorescence images of (left to right) brain, intestine, kidney, and pancreas human tumor sections before (top) and after (bottom) ExPRESSO expansion. Samples were stained with vimentin, pan-Cytokeratin, and Hoechst 33342. The same regions on each tissue were imaged before and after expansion. Enlarged views from each box are shown. Scale bars (the expanded image scale bars indicate the pre-expansion dimensions based on a 3.7-fold expansion): 500 μm (top), 100 μm (top; enlarged), 500 μm (bottom), 100 μm (bottom; enlarged). (6C) Images of ExPRESSO gels made with gaskets of 6 mm diameter are shown (1) unexpanded, (2) fully expanded in ddH₂O, (3) fully expanded then infused with 0.05% Ammonium persulfate (APS), (4) after soaking in neat EtOH, and (5) after infusion with OCT. Scale bars (all scale bars indicate physical measurement): 10 mm. (6D) Representative secondary electron images of an unexpanded tissue (left) and an ExPRESSO-MIBI gel (right) before and after MIBI imaging. Scale bars (all scale bars indicate physical measurement): 200 μm. (6E) Schematic of measurement of thickness of an ExPRESSO gel using a profilometer. (1) Measurements were performed over grooves on the collapsed gel created by a razor blade. (2) Representative image of an ExPRESSO gel under the profilometer camera. (3) A representative image of a depth profile. (4) The distance between the gel surface and the valley floor was calculated as the thickness of the gel, thickness data from six measures on the same gel. (6F) Depth profiling of an ExPRESSO-MIBI sample. Representative 12C (left) and Histone H3 (right) MIBI images of an ExPRESSO treated tonsil sample rastered 15 layers. Cyan arrows indicate the emergence and disappearance of cell nuclei at different depths. The homogeneous 12C signal distribution at multiple depths indicates the homogeneous nature of the ExPRESSO gels (only layers 1, 6, and 11 are shown). Scale bars (the ExPRESSO-MIBI scale bars indicate the pre-expansion dimensions based on a 3.7-fold expansion): 50 μm (left), 25 μm (middle, enlarged) and 50 μm (right). (6G) Left: Unexpanded tonsil section imaged on MIBI in 2.5 nA “superfine” mode and 400 μm, 1024×1024 resolution, grid size of 0.39 μm/pixel. Right: Parallel-stained ExPRESSO tonsil gel imaged on the MIBI with 10 nA “coarse” mode and 400 μm, 256×256 resolution, grid size of 1.56 μm/pixel (4× larger). These parameters in the ExPRESSO sample match the unexpanded MIBI resolution; there was an increase of beam diameter due to increase of current. This experiment demonstrates that with the same ion dose density for the same size pre-expansion tissue area, the ExPRESSO images had higher counts than the unexpanded images in the Histone H3 channel. The increase of current to match the grid size and beam can produce more ions or save more time. Scale bars (the ExPRESSO-MIBI scale bars indicate the pre-expansion dimensions based on a 3.7-fold expansion): 25 μm.

### DETAILED DESCRIPTION

Unless defined otherwise herein, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

All patents and publications, including all sequences disclosed within such patents and publications, referred to herein are expressly incorporated by reference.

Numeric ranges are inclusive of the numbers defining the range. Unless otherwise indicated, nucleic acids are written left to right in 5′ to 3′ orientation; amino acid sequences are written left to right in amino to carboxy orientation, respectively.

The headings provided herein are not limitations of the various aspects or embodiments of the invention. Accordingly, the terms defined immediately below are more fully defined by reference to the specification as a whole.

Unless defined otherwise, all technical and scientific terms used herein have the same meaning as commonly understood by one of ordinary skill in the art to which this invention belongs. Singleton, et al., DICTIONARY OF MICROBIOLOGY AND MOLECULAR BIOLOGY, 2D ED., John Wiley and Sons, New York (1994), and Hale & Markham, THE HARPER COLLINS DICTIONARY OF BIOLOGY, Harper Perennial, N.Y. (1991) provide one of skill with the general meaning of many of the terms used herein. Still, certain terms are defined below for the sake of clarity and ease of reference.

Provided herein is a method for processing a tissue sample. In some embodiments, the method may comprise permeating the tissue sample with monomers for a negatively charged expandible gel, allowing the monomers to polymerize in the tissue sample, hydrating the tissue sample, thereby causing the sample to expand, adhering expanded tissue sample to a positively charged surface and dehydrating the expanded tissue sample while it is on the planar surface.

The tissue sample may be permeated with monomers for a negatively charged expandible gel by placing the sample in a solution containing the monomers for a period of time. Suitable monomers include acrylate and/or acrylamide, although other monomers with similar properties may be used. The tissue sample is then incubated for a period of time to polymerize the monomers in situ, i.e., in the tissue sample. This process produces a gel with the sample embedded in the gel. In some embodiments, the sample may be incubated with the monomers and a catalyst for polymerization. In these embodiments, the permeating may be done by incubating the sample in sodium acrylate, acrylamide and N,N′-methylenebisacrylamide for a period of time, then exposing the sample to ammonium persulfate (APS), and N,N,N′,N′-tetramethyl ethylenediamine (TEMED), and then incubating the sample until the monomers have polymerized into a gel.

The tissue sample may be a piece of tissue that has been obtained from a subject, e.g., a mammal such a human, rodent, primate, etc. In some embodiments, the sample may be a tissue section, e.g., a slice of a tissue. In other embodiments, the sample may be a three dimensional piece of tissue or a whole tissue. In some embodiments, the sample may be “formalin-fixed paraffin embedded (FFPE) tissue section” which refers to a piece of tissue, e.g., a biopsy that has been obtained from a subject, fixed in formaldehyde (e.g., 3%-5% formaldehyde in phosphate buffered saline) or Bouin solution, embedded in wax, cut into thin sections, and then optionally mounted on a microscope slide. Thus, in many embodiments, the sample may be planar. However, non-planar samples may be used too. Tissue sections are planar whereas a non-planar sample is a sample that is not substantially flat, e.g., a whole or part organ mount (e.g., of a lymph node, brain, liver, etc.). In some embodiments, a sample may be made transparent. As will be described below, after the sample has been dehydrated in accordance with the present method, the sample may collapse in the x axis but holds its dimensions in the x-y plane.

After the monomers have polymerized into a negatively charged gel, the sample may be hydrated, e.g., by incubating the sample in an aqueous medium such as a liquid comprising at least 90% water, e.g., at least 95% water, at least 98% water or at least 99% water (e.g., buffered water). The water enters the sample and causes the sample to swell or expand. This step may cause the sample to swell to at least 2×, at least 4×, or at least 5× of its original size, although it may be possible to expand the sample to an even greater size if the method is optimized or improved. This step may cause the sample to swell 2×-5×. This swollen sample is referred to as an expanded sample herein.

After the sample has expanded, the sample is adhered to a positively charged surface. This may be done by placing the expanded tissue sample on a planar substrate that that contains a positively charged surface, e.g., a planar substrate that has been silanized. The forces of attraction between the negatively charged gel and positively charged substrate hold the sample in its expanded state in the x-y plane during the next steps of the method.

In the next step of the method, the sample is dehydrated while it is adhered to the substrate. This step may be done by any suitable method, e.g., by exposing the sample to a buffer that has high osmolarity (e.g., a buffer that contains salt), treating the sample with an ethanol series and/or by placing the sample and substrate in a desiccation or vacuum chamber. Other methods for dehydrating the sample could be used. In this step, the sample may contract in the z dimension to some extent, flattening the sample.

In some embodiments, the sample may be a formalin fixed tissue section. In these embodiments, the method may further comprise, before step (a) (i.e., before permeating the tissue sample with monomers for a negatively charged expandible gel) the method may comprise: (i) treating the tissue section with heat in order to break crosslinks in the section; and (ii) incubating the tissue section with acrylamide to quench any reactive methylols; between steps (b) and (c) (after the monomers have polymerized but before hydration), (iii) treating the sample with a denaturing agent; and (iv) staining the tissue section with one or more antibodies; and after step (e) (after dehydration) (v) analyzing the binding of the one or more antibodies to the tissue section. This embodiment does not require a proteolysis step and therefore may be done without a protease treatment step. However, in some embodiments, the sample may be treated with a protease, e.g., immediately before, during or immediately after step (iii). Any type of sample, including samples that have not been fixed may be treated with acrylamide as described below, since provides a way to anchor or tether proteins to the gel matrix.

In these embodiments, the heat treatment may include heating the sample at a temperature of 60 ºC for at least 30 mins (e.g., at least 90° C. for more than 30 mins). This step, which may be referred to as heat induced epitope retrieval (HIER) includes the use of heat and, in some embodiments, a buffered solution to recover antigen reactivity in formalin fixed paraffin embedded tissue. This step may be done in a steamer, water bath or microwave at a temperature in the range of 94° C. to 100° ° C. Pressure cookers may also be used. The lower the temperature, the longer the heat exposure required to produce an equivalent intensity of staining observed with a higher temperature. Thus, the appropriate adjustment of the heating time to compensate for maximum temperature differences allows for the use of any of the listed heat sources to produce comparable staining intensities. The pH of the buffer may be adjusted accordingly. Optimal recovery for most epitopes occurs in alkaline buffers with a pH range of 8-10. If the sample is paraffin embedded then the sample may be de-paraffinizing in this step, e.g., using a solvent.

The acrylamide treatment step may be done by incubating the sample with at least 20% acrylamide (e.g., 20% to 50% acrylamide for at least one hour (e.g., 2 to 40 hrs)). For example, this step can be performed by incubating the sample in 20-40% acrylamide for 12-24 hr). In this step, the acrylamide binds to proteins, and prevents protein-protein crosslinking. The bound acrylamide also serves to equip proteins with a gel anchorable moiety, since acrylamide can participate in free radical polymerization just as acrylate does. After immersion of the specimen in a mixture of sodium acrylate and acrylamide, and formation of the resulting interpenetrating gel throughout the specimen, incubation in a high-temperature detergent solution causes denaturation of proteins and allows them to be separated when the tissue is expanded in water. This step is thought to prevents protein crosslinking by quenching reactive methylols formed by the protein-formaldehyde reaction while, at the same time providing a way for the proteins to become tethered to the gel.

The denaturing step may be done by immersing the sample in a solution containing sodium dodecyl sulfate (SDS).

After the sample has been denatured, one or more binding agents (e.g., a cocktail of antibodies or oligonucleotides) may be bound to the sample en masse, where the different binding agents bind to different antigens or nucleic acids. In these embodiments, the cocktail may contain at least 10 binding agents, at least 20 binding agents, at least 50 binding agents, or at least 100 binding agents, as desired.

The binding agents may be mass-tagged, fluorescently labeled or conjugated to an oligonucleotide, for example. The analysis may be done by multiplexed ion beam imaging (MIBI), imaging mass cytometry (IMC) or co-detection by indexing (CODEX), for example, a summary of which is provided below.

The multiplexed binding assay may be done by detecting binding of at least 10, at least 20, at least 50, up to 100 or 300 binding agents (e.g., antibodies) to the sample. This method may involve cross-linking the antibodies to the sample, if desired. Methods for performing multiplexed binding assay include, but are not limited to, multiplex colorimetric immunohistochemistry (mCIHC), multiplex immunofluorescence (mIF), cyclic immunofluorescence (CycIF), iterative indirect immunofluorescent imaging (4i), imaging mass cytometry (IMC), multiplexed ion beam imaging (MIBI), codetection by indexing (CODEX), and digital spatial profiling (DSP). These methods are reviewed in, e.g., Patel et al (Methods Mol Biol. 2020 2055:455-465) and Francisco-Cruz et al (Methods Mol. Biol. 2020 2055: 467-495). The general principles of CycIF are described in Rashid et al. Sci. Data. 2019 6: 323 and Lin et al. eLife 2018 10: 31657. The general principles of 4i are described in Gut et al (Science 2018 361: 1-13). The general principles of IMC and MIBI, which are mass-spectrometry approaches for performing multiplexed tissue labeling, are described in a variety of publications including, but not limited to Angelo et al. (Nature Medicine 2014 20:436), Rost et al. (Lab. Invest. 2017 97: 992-1003) U.S. Pat. Nos. 9,766,224, 9,312,111 and US2015/0080233, among many others.

The general principles of CODEX are described in Goltsev et al. (Cell 2018 174: 968-981), Schürch et al. (bioRxiv 2019 743989) and US20180030504. CODEX-based implementations of the method may involve (a) obtaining: i. a plurality of capture agents (e.g., 20-200 antibodies) that are each linked to a different oligonucleotide; and ii. a corresponding plurality of labeled nucleic acid probes, wherein each of the labeled nucleic acid probes specifically hybridizes with only one of the oligonucleotides; (b) labeling the sample with the plurality of capture agents; (c) specifically hybridizing a first sub-set (e.g., 2, 3, or 4) of the labeled nucleic acid probes of (a)(ii) with the sample, wherein the probes in the first sub-set are distinguishably labeled, to produce labeled probe/oligonucleotide duplexes; (d) reading the sample to obtain an image showing binding pattern for each of the probes hybridized in step (c); (e) inactivating or removing the labels that are associated with the sample in step (c), leaving the plurality of capture agents of (b) and their associated oligonucleotides still bound to the sample; and (f) repeating steps (c) and (d) multiple times with a different sub-set of the labeled nucleic acid probes of (a)(ii), each repeat followed by step (e) except for the final repeat, to produce a plurality of images of the sample, each image corresponding to a sub-set of labeled nucleic acid probes used in (c). In these embodiments, multiple images may be registered and superimposed. Using any method, the image(s) provide information on the amount of each antibody that is bound to the sample as well as the location of the epitope to which it binds.

In some of these embodiments, the analysis may involve exposing the tissue sample to vacuum conditions. In other of these embodiments, the analysis may involve exposing the tissue sample to solutions that have salt or chaotropic agents in them (e.g., binding, hybridization and wash buffers), which may remove water from the sample. The samples stay in their expanded form during analysis and because the proteins are cross-linked to the gel (and not to each other) their spatial relationships are maintained.

Also provided is an intermediate composition comprising expanded dehydrated tissue section embedded in a negatively charged gel, mounted on a positively charged planar support. Further additions, modifications and embodiments of this composition may be apparent in view of the foregoing discussion.

### Kits

Also provided by this disclosure are kits that contain reagents for practicing the subject methods, as described above. In some embodiments, the kit may comprise a substrate that has a positively charged surface; acrylamide and or acrylate; and an antibody cocktail that may contain at least 10 antibodies (e.g., at least 15, at least 20, at least 30, at least 40 different antibodies). The various components of the kit may be present in separate containers or certain compatible components may be precombined into a single container, as desired. In addition to above-mentioned components, the subject kits may further include instructions for using the components of the kit to practice the subject methods, i.e., instructions for sample analysis.

### Utility

The methods and compositions described herein find general use in a wide variety of applications for analysis of a biological sample (e.g., in the analysis of tissue sections, sheets of cells, spun-down cells, whole tissues or parts thereof, etc.). The method may be used to analyze any tissue, including tissue that has been clarified, e.g., through lipid elimination, for example. In particular embodiments, the sample may be a section of a tissue biopsy obtained from a patient. Biopsies of interest include both tumor and non-neoplastic biopsies of skin (melanomas, carcinomas, etc.), soft tissue, bone, breast, colon, liver, kidney, adrenal, gastrointestinal, pancreatic, gall bladder, salivary gland, cervical, ovary, uterus, testis, prostate, lung, thymus, thyroid, parathyroid, pituitary (adenomas, etc.), brain, spinal cord, ocular, nerve, and skeletal muscle, etc.

In certain embodiments, capture agents specifically bind to biomarkers, including cancer biomarkers, that may be proteinaceous. Exemplary cancer biomarkers, include, but are not limited to carcinoembryonic antigen (for identification of adenocarcinomas), cytokeratins (for identification of carcinomas but may also be expressed in some sarcomas), CD15 and CD30 (for Hodgkin's disease), alpha fetoprotein (for yolk sac tumors and hepatocellular carcinoma), CD117 (for gastrointestinal stromal tumors), CD10 (for renal cell carcinoma and acute lymphoblastic leukemia), prostate specific antigen (for prostate cancer), estrogens and progesterone (for tumour identification), CD20 (for identification of B-cell lymphomas) and CD3 (for identification of T-cell lymphomas).

The above-described method can be used to analyze cells from a subject to determine, for example, whether the cell is normal or not or to determine whether the cells are responding to a treatment. In one embodiment, the method may be employed to determine the degree of dysplasia in cancer cells. In these embodiments, the cells may be a sample from a multicellular organism. A biological sample may be isolated from an individual, e.g., from a soft tissue. In particular cases, the method may be used to distinguish different types of cancer cells in FFPE samples.

The method described above finds particular utility in examining samples using a plurality of antibodies, each antibody recognizing a different marker. Examples of cancers, and biomarkers that can be used to identify those cancers, are shown below. In these embodiments, one does not need to examine all of the markers listed below in order to make a diagnosis.

| | |
|---|---|
| Acute Leukemia IHC Panel | CD3, CD7, CD20, CD34, CD45, CD56, CD117, |
| | MPO, PAX-5, and TdT. |
| Adenocarcinoma vs. Mesothelioma IHC Panel | Pan-CK, CEA, MOC-31, BerEP4, TTF1, |
| | calretinin, and WT-1. |
| Bladder vs. Prostate Carcinoma | CK7, CK20, PSA, CK 903, and p63. |
| IHC Panel | |
| Breast IHC Panel | ER, PR, Ki-67, and HER2. Reflex to HER2 |
| | FISH after HER2 IHC is available. |
| Burkitt vs. DLBC Lymphoma IHC | BCL-2, c-MYC, Ki-67. |
| panel | |
| Carcinoma Unknown Primary Site, | CK7, CK20, mammaglobin, ER, TTF1, CEA, |
| Female (CUPS IHC Panel-Female) | CA19-9, S100, synaptophysin, and WT-1. |
| Carcinoma Unknown Primary Site, | CK7, CK20, TTF1, PSA, CEA, CA19-9, S100, |
| Male (CUPS IHC Panel-Male) | and synaptophysin. |
| GIST IHC Panel | CD117, DOG-1, CD34, and desmin. |
| Hepatoma/Cholangio vs. | HSA (HepPar 1), CDX2, CK7, CK20, CAM 5.2, |
| Metastatic Carcinoma IHC Panel | TTF-1, and CEA (polyclonal). |
| Hodgkin vs. NHL IHC Panel | BOB-1, BCL-6, CD3, CD10, CD15, CD20, |
| | CD30, CD45 LCA, CD79a, MUM1, OCT-2, |
| | PAX-5, and EBER ISH. |
| Lung Cancer IHC Panel | chromogranin A, synaptophysin, CK7, p63, and |
| | TTF-1. |
| Lung vs. Metastatic Breast | TTF1, mammaglobin, GCDFP-15 (BRST-2), and |
| Carcinoma IHC Panel | ER. |
| Lymphoma Phenotype IHC Panel | BCL-2, BCL-6, CD3, CD4, CD5, CD7, CD8, |
| | CD10, CD15, CD20, CD30, CD79a, CD138, |
| | cyclin D1, Ki67, MUM1, PAX-5, TdT, and |
| | EBER ISH. |
| Lymphoma vs. Carcinoma IHC | CD30, CD45, CD68, CD117, pan-keratin, MPO, |
| Panel | S100, and synaptophysin. |
| Lymphoma vs. Reactive | BCL-2, BCL-6, CD3, CD5, CD10, CD20, CD23, |
| Hyperplasia IHC Panel | CD43, cyclin D1, and Ki-67. |
| Melanoma vs. Squamous Cell | CD68, Factor XIIIa, CEA (polyclonal), S-100, |
| Carcinoma IHC Panel | melanoma cocktail (HMB-45, MART-1/Melan- |
| | A, tyrosinase) and Pan-CK. |
| Mismatch Repair Proteins IHC | MLH1, MSH2, MSH6, and PMS2. |
| Panel (MMR/Colon Cancer) | |
| Neuroendocrine Neoplasm IHC | CD56, synaptophysin, chromogranin A, TTF-1, |
| Panel | Pan-CK, and CEA (polyclonal). |
| Plasma Cell Neoplasm IHC Panel | CD19, CD20, CD38, CD43, CD56, CD79a, |
| | CD138, cyclin D1, EMA, kappa, lambda, and |
| | MUM1. |
| Prostate vs. Colon Carcinoma IHC | CDX2, CK 20, CEA (monoclonal), CA19-9, |
| Panel | PLAP, CK 7, and PSA. |
| Soft Tissue Tumor IHC Panel | Pan-CK, SMA, desmin, S100, CD34, vimentin, |
| | and CD68. |
| T-Cell Lymphoma IHC panel | ALK1, CD2, CD3, CD4, CD5, CD7, CD8, |
| | CD10, CD20, CD21, CD30, CD56, TdT, and |
| | EBER ISH. |
| T-LGL Leukemia IHC panel | CD3, CD8, granzyme B, and TIA-1. |
| Undifferentiated Tumor IHC Panel | Pan-CK, S100, CD45, and vimentin. |

In some embodiments, the method may involve obtaining an image of the sample, e.g., an image showing the binding pattern of antibodies to the sample (an electronic form of which may have been forwarded from a remote location), and the image may be analyzed by a doctor or other medical professional to determine whether a patient has abnormal cells (e.g., cancerous cells) or which type of abnormal cells are present. The image may be used as a diagnostic to determine whether the subject has a disease or condition, e.g., a cancer. In certain embodiments, the method may be used to determine the stage of a cancer, to identify metastasized cells, or to monitor a patient's response to a treatment, for example.

The compositions and methods described herein can be used to diagnose a patient with a disease. In some cases, the presence or absence of a biomarker in the patient's sample can indicate that the patient has a particular disease (e.g., cancer). In some cases, a patient can be diagnosed with a disease by comparing a sample from the patient with a sample from a healthy control. In this example, a level of a biomarker, relative to the control, can be measured. A difference in the level of a biomarker in the patient's sample relative to the control can be indicative of disease. In some cases, one or more biomarkers are analyzed in order to diagnose a patient with a disease. The compositions and methods of the disclosure are particularly suited for identifying the presence or absence of, or determining expression levels, of a plurality of biomarkers in a sample.

In some cases, the compositions and methods herein can be used to determine a treatment plan for a patient. The presence or absence of a biomarker may indicate that a patient is responsive to or refractory to a particular therapy. For example, a presence or absence of one or more biomarkers may indicate that a disease is refractory to a specific therapy, and an alternative therapy can be administered. In some cases, a patient is currently receiving the therapy and the presence or absence of one or more biomarkers may indicate that the therapy is no longer effective.

In any embodiment, data can be forwarded to a “remote location”, where “remote location,” means a location other than the location at which the image is examined. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or at least one hundred miles apart. “Communicating” information refers to transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. Examples of communicating media include radio or infra-red transmission channels as well as a network connection to another computer or networked device, and the internet or including email transmissions and information recorded on websites and the like. In certain embodiments, the image may be analyzed by an MD or other qualified medical professional, and a report based on the results of the analysis of the image may be forwarded to the patient from which the sample was obtained.

In some cases, the method may be employed in a variety of diagnostic, drug discovery, and research applications that include, but are not limited to, diagnosis or monitoring of a disease or condition (where the image identifies a marker for the disease or condition), discovery of drug targets (where the a marker in the image may be targeted for drug therapy), drug screening (where the effects of a drug are monitored by a marker shown in the image), determining drug susceptibility (where drug susceptibility is associated with a marker) and basic research (where is it desirable to measure the differences between cells in a sample).

In certain embodiments, two different samples may be compared using the above methods. The different samples may be composed of an “experimental” sample, i.e., a sample of interest, and a “control” sample to which the experimental sample may be compared. In many embodiments, the different samples are pairs of cell types or fractions thereof, one cell type being a cell type of interest, e.g., an abnormal cell, and the other a control, e.g., normal, cell. If two fractions of cells are compared, the fractions are usually the same fraction from each of the two cells. In certain embodiments, however, two fractions of the same cell may be compared. Exemplary cell type pairs include, for example, cells isolated from a tissue biopsy (e.g., from a tissue having a disease such as colon, breast, prostate, lung, skin cancer, or infected with a pathogen, etc.) and normal cells from the same tissue, usually from the same patient; cells grown in tissue culture that are immortal (e.g., cells with a proliferative mutation or an immortalizing transgene), infected with a pathogen, or treated (e.g., with environmental or chemical agents such as peptides, hormones, altered temperature, growth condition, physical stress, cellular transformation, etc.), and a normal cell (e.g., a cell that is otherwise identical to the experimental cell except that it is not immortal, infected, or treated, etc.); a cell isolated from a mammal with a cancer, a disease, a geriatric mammal, or a mammal exposed to a condition, and a cell from a mammal of the same species, preferably from the same family, that is healthy or young; and differentiated cells and non-differentiated cells from the same mammal (e.g., one cell being the progenitor of the other in a mammal, for example). In one embodiment, cells of different types, e.g., neuronal and non-neuronal cells, or cells of different status (e.g., before and after a stimulus on the cells) may be employed. In another embodiment of the invention, the experimental material contains cells that are susceptible to infection by a pathogen such as a virus, e.g., human immunodeficiency virus (HIV), etc., and the control material contains cells that are resistant to infection by the pathogen. In another embodiment, the sample pair is represented by undifferentiated cells, e.g., stem cells, and differentiated cells.

The images produced by the method may be viewed side-by-side or, in some embodiments, the images may be superimposed or combined. In some cases, the images may be in color, where the colors used in the images may correspond to the labels used.

Cells from any organism, e.g., from bacteria, yeast, plants and animals, such as fish, birds, reptiles, amphibians and mammals may be used in the subject methods. In certain embodiments, mammalian cells, i.e., cells from mice, rabbits, primates, or humans, or cultured derivatives thereof, may be used.

### Examples

This disclosure provides a method referred to as Expand and comPRESS hydrOgels (or “ExPRESSO” for short), which enables high-plex protein staining in tissues that have been expanded and then dehydrated. ExPRESSO imaging of archival clinical tissue samples has been demonstrated using 21 concurrent markers on the Multiplexed Ion Beam Imaging (MIBI) and Imaging Mass Cytometry (IMC) platforms, with scalability to >40 markers following further antibody optimization. Applicability of ExPRESSO is shown with archival human lymphoid and brain tissues to resolve orchestrated features of multi-cellular organization and tissue architecture at the subcellular level, particularly that of the blood brain barrier (BBB). ExPRESSO provides a platform for extending the repertoire of analyses compatible with biological specimens that are physically expanded using hydrogels, with streamlined integration into existing tissue preparation protocols and instrumentation, while retaining re-interrogation capabilities after long-term storage.

### Methods

Human Tissue Acquisition and Patient Consent: Archival human FFPE tissues, including tonsil (from the same donor), brain (hippocampus and middle frontal gyrus were from the same donor), and tumor (of spleen, kidney, intestine, brain, and pancreas) were obtained from Stanford Pathology Department. The post-mortem interval of the brain tissue was 2.8 hours. Clinical diagnosis and neuropathological scores were generated by Stanford clinicians and pathologists. The clinical diagnosis was based on DSM-IV criteria. AD neuropathologic change and severity scores were evaluated by NIA-AA guidelines (Hyman et al., 2012; Montine et al., 2011). Neuropsychological test results within 1 year of death were in the upper three quartiles for the study. The brain samples were sectioned at a thickness of 4 μm, while tonsil and tumor samples were sectioned at 2 μm thickness. Antibody Conjugation and Panel: Antibody conjugation was performed as previously described (Han et al., 2018) using the Maxpar X8 Multimetal Labeling Kit (Fluidigm, 201300) and Ionpath Conjugation Kits (Ionpath, 600XXX) with slight modifications to manufacturers' protocols. In short, 100 μg BSA-free antibody was first washed with the conjugation buffer, then reduced using a final concentration of 4 μM TCEP (Thermo Fisher Scientific, 77720) to reduce the thiol groups for 30 min in a 37° C. water bath. The reduced antibody was then mixed and incubated with lanthanide-loaded polymers for 90 min in a 37° C. water bath, then washed five times with an Amicon Ultra filter (Millipore Sigma, UFC505096). The resulting conjugated antibody was quantified using a NanoDrop (Thermo Scientific, ND-2000) in IgG mode, at 280 nm, and the final concentration was adjusted to at least 30% v/v Candor Antibody Stabilizer (Thermo Fisher Scientific, NC0414486). Samples were stored at 4° C.

Gold Slide Preparation: The protocol of preparing gold slides has been described previously (Ji et al., 2020; Keren et al., 2018, 2019). In short, Superfrost Plus glass slides (Thermo Fisher Scientific, 12-550-15) were first soaked and briefly supersonicated in dish detergent diluted in doubly distilled water (ddH₂O), cleaned using Microfiber Cleaning Cloths (Care Touch, BD11945) then rinsed in ddH₂O to remove any remaining detergent. After that, the slides were air-dried with a constant stream of air in the fume hood. The coating of 30 nm of tantalum followed by 100 nm of gold was performed by the Microfab Shop of Stanford Nano Shared Facility (SNSF) and New Wave Thin Films (Newark, CA).

Vectabonding: To introduce positive charges for better adhesion of gels or tissue sections onto the surface, pre-cleaned glass slides or the gold slides were silanized with Vectabond Reagent (Vector Labs, SP-1800-7) as per the protocol supplied by the manufacturer. The slides were first soaked in neat acetone for 5 min, then transferred into 1:50 diluted Vectabond Reagent in acetone and incubated for 10 min. After that, slides were quickly dipped in ddH₂O to quench and remove remaining reagents, then tapped on a Kimwipe to remove remaining water. The resulting slides were air-dried then stored at room temperature.

### ExPRESSO Protocol

All chemicals used were purchased from Sigma-Aldrich and used without further purification, if not specified.

Antigen retrieval and hydrogel embedding. FFPE tissue blocks were sectioned onto glass slides at the Stanford Pathology Core. Slides with FFPE sections were first baked in a dry oven (VWR, 10055-006) for 1 h at 70° C., then were transferred into neat xylene and incubated for 10 min followed by transfer into xylene and incubation for another 10 min. Standard deparaffinization was performed with a linear stainer (Leica Biosystems, ST4020) in the following sequence: three times in xylene, three times in 100% EtOH, twice in 95% EtOH, once in 80% EtOH, once in 70% EtOH, and three times in ddH₂O, 180 s each dip. Antigen retrieval was then performed at 97° C. for 40 min with Target Retrieval Solution (Agilent, S236784-2) on a PT Module (Thermo Fisher Scientific, A80400012).

After removal from the PT Module, the cassette with slides and solution was left on the benchtop until it reached room temperature. Slides were rinsed with 1×PBS, then soaked in 30% (w/w) acrylamide in 1×PBS at 37° ° C. for 18 h. Tissue sections were then washed with 1×PBS for 5 min.

Monomer solution (1×PBS, 2 M NaCl, 8.6% (w/w) sodium acrylate, 2.5% (w/w) acrylamide and 0.10% (w/w) N,N′-methylenebisacrylamide (BIS)), Ammonium persulfate (APS), and N,N,N′,N′-Tetramethyl ethylenediamine (TEMED) solutions were prepared as previously described (Tillberg et al., 2016). Tissue sections were then incubated with monomer solution for 10 min at room temperature. Meanwhile, a gelation chamber for thin gel was prepared with two strips of #0 coverslip (EMS, 72198-10) as spacers along with one piece of glass slide, similarly to the 10× ExM protocol (Truckenbrodt et al., 2019).

The monomer solution was aspirated from the tissue sections carefully, then the slide with the sections was flipped and bridged between the two strips of #0 coverslip to form the gelation chamber. TEMED then APS was mixed with a new tube of monomer solution on ice, then around 30-50 μL of this solution was added through the gap between glass slide and slide with sections to avoid formation of bubbles. This gelation chamber was then incubated in a humidity chamber at 37° C. for 1 h.

Gel denaturation and cleaning. Gelation chamber was carefully disassembled with a clean razor blade, then slides with gel-embedded tissue sections were transferred into denaturing buffer (200 mM SDS, 200 mM NaCl, and 50 mM Tris in ddH₂O water, pH 9.0) and incubated for ˜18 hours at 70° C. in a water bath. Denaturing buffer was renewed, and the gel was incubated with the denaturing buffer further at 95° C. for 1 h in a PT Module. After the solution was cooled to room temperature, the denaturing buffer was then replaced with 1×PBS with 1% Triton X-100 and incubated 30 min at room temperature with rotation; this was performed three times to remove the SDS.

Antibody staining. The gel was first incubated in 1× blocking medium (0.5% BSA, 0.05% (wt/vol) NaN₃ in 1×PBS) for 30 min. Meanwhile, the antibody cocktail was prepared by diluting the lanthanide-conjugated antibodies into antibody diluent (3% normal donkey serum with 0.5% BSA in 1×TBS IHC wash buffer with Tween 20 (Cell Marque, 935B-09)). The gel-embedded tissue section was then incubated with antibody cocktails at 37° C. for ˜18 h while rotating at 25 RPM. After that, the gel was washed three times with washing buffer (0.1% BSA in 1×TBS IHC wash buffer with Tween 20) for 30 min each wash at 37° C. with rotation. The gel was soaked in 1×PBS, then fixed in post-fixation buffer (3% Paraformaldehyde (EMS, 15710), 1.5% Glutaraldehyde (EMS, 16120) in 1×PBS buffer) for 10 min at room temperature. This reaction was quenched by 100 mM Tris-HCl (pH 8.0) for 10 min at room temperature.

Expansion. The gel with the tissue section was transferred into a 100 mM NH₄OAc solution and rotated for 2 h at room temperature, then expanded in 0.5 mM NH₄OAc until no further expansion was observed (usually three washes of 30 min).

Adhesion and collapse of gel. The gel was then carefully lifted with a piece of coverslip and placed on top of a glass slide pretreated with Vectabond for IMC or a gold slide for MIBI with the tissue side up. Excessive water was carefully removed with a Kimwipe, then the slide with gel was placed in a sealed dry chamber with Drierite (W. A. Hammond, 23001) and incubated at room temperature overnight or until the gel formed a continuous layer of dry film. The resulting gel can be stored in a desiccated vacuum chamber for 6 months prior to imaging.

MIBI Protocol: The procedure for MIBI staining was previously described (Jiang et al., 2021; Keren et al., 2018; Rovira-Clavé et al., 2021b). Briefly, the FFPE block was sectioned onto Vectabond-treated gold slides. After deparaffinization and antigen retrieval process as described in the ExPRESSO protocol, the section was blocked by BBDG (5% normal donkey serum, 0.05% NaN₃ in 1×TBS IHC wash buffer with Tween 20), then stained with an antibody cocktail at 4° C. overnight. Subsequently, the sample was washed and post-fixed as described in the ExPRESSO protocol step, before undergoing a series of dehydration steps on the linear stainer (three washes with 100 mM Tris pH 7.5, three washes with ddH₂O, one wash with 70% EtOH, one wash with 80% EtOH, two washes with 95% EtOH, three washes with 100% EtOH, 180 s for each wash), before storage in a vacuum desiccator until acquisition.

MIBI-TOF Imaging and Image Processing: Datasets were acquired on a custom MIBI-TOF mass spectrometer equipped with an oxygen duoplasmatron ion gun (Alpha), a custom MIBI-TOF mass spectrometer (Betty) equipped with a xenon ion source (Hyperion, Oregon Physics), and a commercially available MIBIscope™ System from Ionpath equipped with a xenon ion source.

Alpha MIBI;
Pixel dwell time: 5 ms
Image area: 400 μm×400 μm
Image size: 512×512 pixels
Probe size: ˜ 400 nm
Primary ion current: 3.6 nA on a built-in Faraday cup
Number of depths: 3

Betty MIBI:
Pixel dwell time: 1 ms
Image area: 400 μm×400 μm
Image size: 1024×1024 pixels
Probe size: ˜ 400 nm
Primary ion current: ˜ 5 nA on a built-in Faraday cup
Number of depths: 1 depth for unexpanded tissues and ExPRESSO tonsil samples, 2
depths for ExPRESSO brain samples

Production MIBI:
Pixel dwell time: 1 ms
Image area: 400 μm×400 μm
Image size: 1024×1024 pixels
Probe size: ˜ 400 nm
Primary ion current: 4.9 nA on a built-in Faraday cup (or the “Fine” imaging mode)
Number of depths: 1 depth

MIBI image processing, including image extraction and noise removal, was performed using MIBI Analysis tools as previously described (Baranski et al., 2021; Keren et al., 2018). For MIBI images that were acquired over multiple Z-depths, samples were aligned and summed using the Ki-67 (tonsil) or Histone H3 (brain) channels. Imaging stitching was performed with custom MatLab scripts initially developed by Dmitry Tebaykin and flat-field correction by Sizun Jiang.

IMC Acquisition and Image Processing: ExPRESSO samples and FFPE tissue sections on glass slides were ablated after staining using the Hyperion Imaging Mass Cytometry (Fluidigm). Before data acquisition, the Hyperion was auto-tuned using a three-element tuning slide (Fluidigm). Regions of interest were ablated at a frequency of 200 Hz with an ablation energy of 0 and 1 dB for the ExPRESSO samples and FFPE tissue sections, respectively. MCD and txt files were exported and visualized with the MCD viewer from Fluidigm. MCD files were converted to single-marker tiff images using a custom Python script developed by the Bodenmiller group, and denoising was performed as described in the MIBI-TOF image processing above.

### Image Segmentation

Cell segmentation was performed with a local implementation of deepcell-tf 0.6.0 or 0.9.1 as described (Greenwald et al., 2021; Valen et al., 2016). Cell segmentation in the tonsil images was performed using Histone H3 for the nucleus and CD45 for membrane features. For the brain images (hippocampus and middle frontal gyrus), Histone H3 was used for the nucleus channel and a dummy (all-zero) image was used as the membrane channel. Signals from these channels were first capped at the 99.7th percentile before input into the model. The deepcell-tf version used to generate the final segmentation mask.

Brain Cell Phenotyping: Cells were clustered with the R package FlowSOM (Gassen et al., 2015) based on the following markers: Iba1 (microglia), HLA-DR (microglia), GFAP and GlnSyn (astrocyte), CD105, Fibrinogen, SMA, GLUT1, vWF, Albumin, and CD36 (endothelial related). Thirty meta clusters were extracted and merged into four main categories.

MIBI Image Analysis: The distance between two different features on the same piece of tissue pre- and post-ExPRESSO was measured and the ratio was calculated. Area: Nuclear staining (with Hoechst 33342) of four FFPE tonsils were imaged pre- and post-ExPRESSO, the areas of tissues were measured in ImageJ, and the ratio was calculated. Segment: Four 1200×1200 μm tiles of ExPRESSO-MIBI tonsil images and four 1200×1200 μm tiles of MIBI tonsil images were segmented as described in the Image Segmentation section. The cell size distribution ratio was calculated.

Different but nearby regions of the same piece of ExPRESSO-MIBI tonsil gel were imaged on 2021-07-27, 2021-09-17, and 2022-02-18 under the same imaging parameters. Histone H3 and dsDNA signals of five different fields of view (FOVs) from each batch were summed and plotted.

The same piece of ExPRESSO tonsil gel was imaged on MIBI with the same FOV size and resolution but different currents. The Histone H3 and dsDNA signals were averaged across two or three runs for each condition.

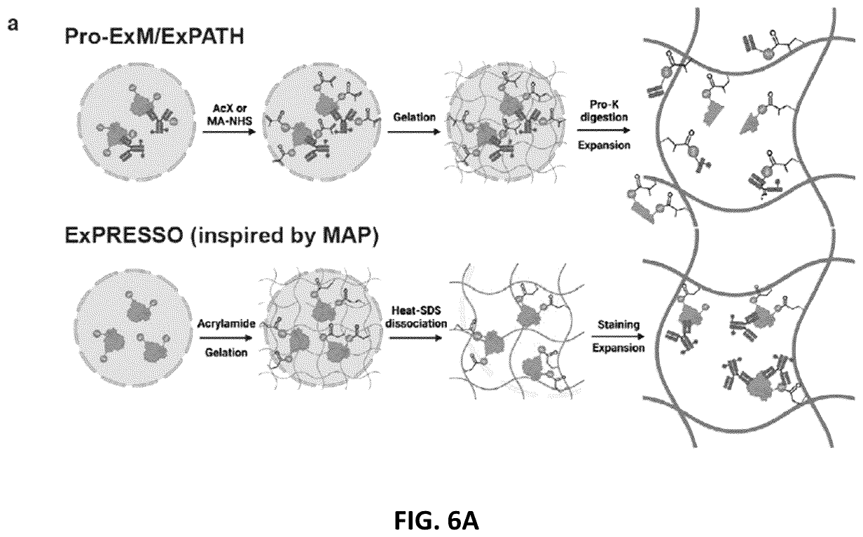

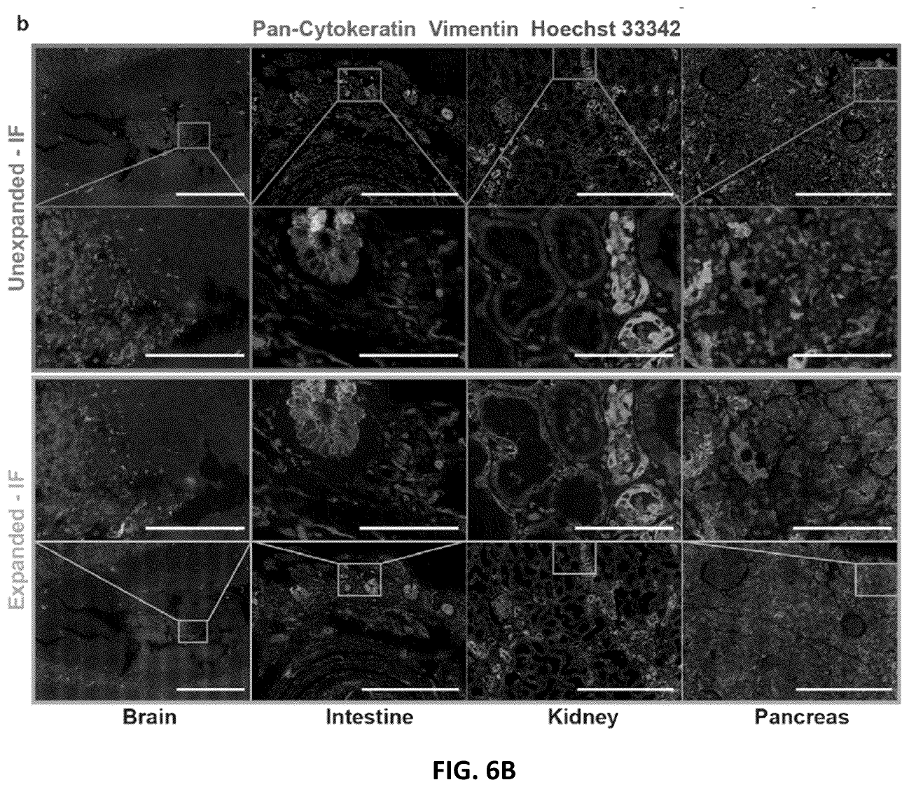

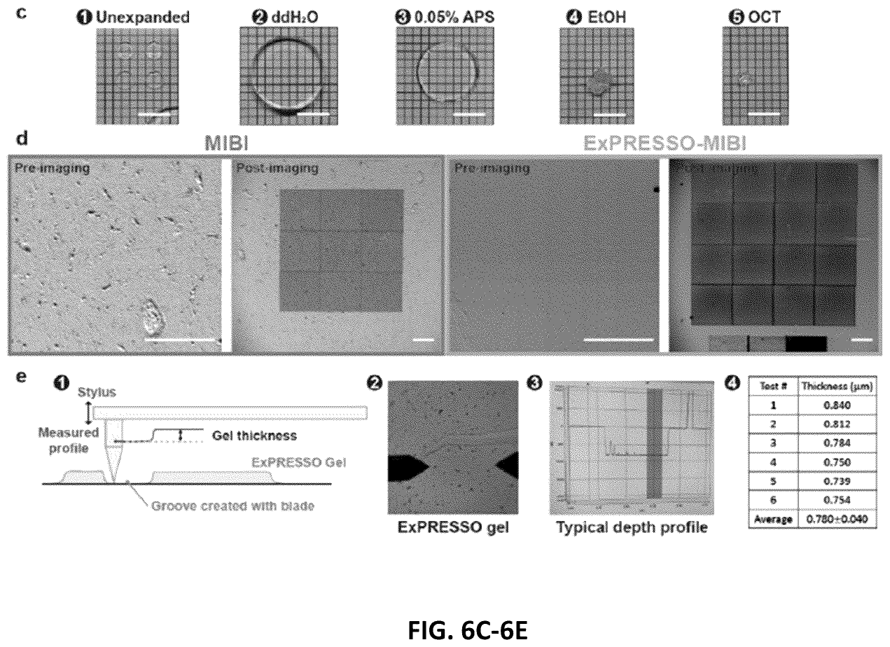

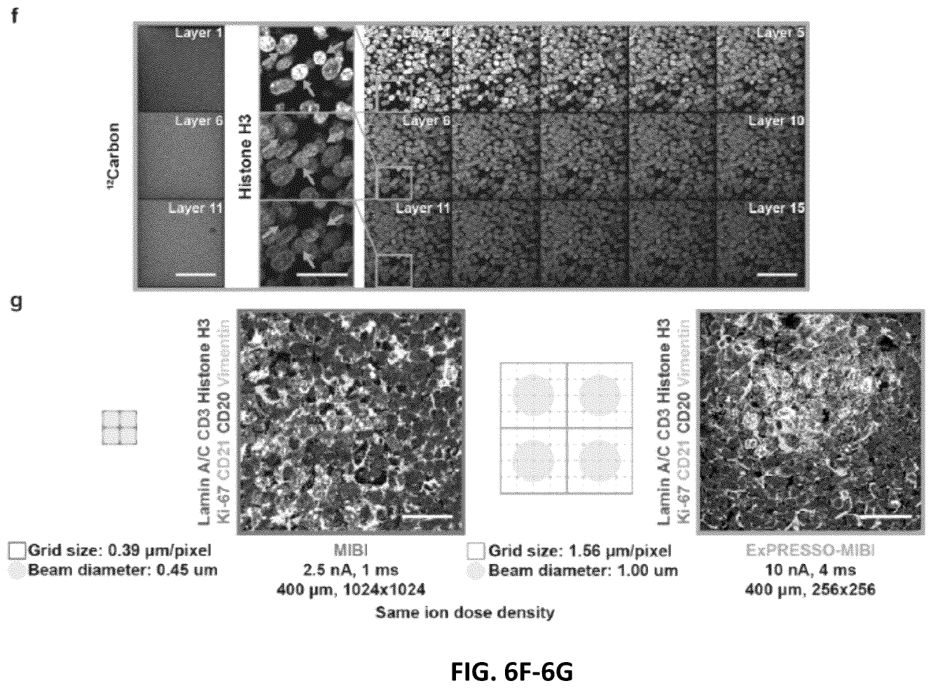

A MIBI tonsil sample and a parallel ExPRESSO-MIBI tonsil gel were imaged with the same ion dose density, but the grid size of the ExPRESSO sample was four times that of the MIBI (FIG. 6G). Average Histone H3 counts from three runs are shown for each condition.

For both unexpanded and ExPRESSO, images after background removal but without denoising were used. The line profiles were generated with ImageJ. The ExPRESSO images were scaled down by expansion fold to match the unexpanded images.

For the three selected channels (CD56, MAG, and GFAP), the signals of the 1×16 stitched images were summed perpendicular to the long axis to get the expression level changes along the long axis. Then the expression level for each protein were Min-Max normalized within each channel, where the Min is the 5% quantile and Max is the 95% quantile value for the individual markers. Subsequently, each ‘step’ was defined as 200 adjacent vertical pixel lines with the MIBI scans across regions. Each ‘step’ slides 50 pixels lines in horizontal direction relative to the previous ‘step’ (e.g., step 1: vertical row #1-200, step 2: vertical row #50-250). The normalized average value of individual marker expression levels in each ‘step’ were then plotted, along with the 95% confidence intervals.

The brain vessel object was identified as described in the previous section and then the microenvironment around each individual vessel was extracted layer-by-layer through stepwise morphology operation on the vessel feature segment objects. Each ‘step’ area was defined as the 1 pixel-width extension/inclusion area around the vessel mask, which was generated by subtracting the results from MATLAB functions: imdilate( ) and imerode( ) To avoid interference from neighboring vessels during the area extensioning, the areas of each ‘step’ that overlapped with other non-dilated vessel objects were removed. Subsequently, the marker expression level, cell phenotype fraction (number of pixels for certain cell types in fraction of the total pixels numbers in each ‘step’ area), and non-nuclear feature segment object fraction (number of pixels for certain non-nuclear feature segment object in fraction of the total pixels numbers in each ‘step’) were extracted.

For downstream analysis, values from each step area of each individual vessel were square-root transformed for visualization purposes. In the line plot, average counts and 95% confidence intervals were plotted (EXPRESSO-MIBI samples:−40 to +20 pixels; MIBI sample:−10 to +5 pixels). For the heatmap of marker expressions along the ‘steps’ of brain vessels, the expression levels for each marker were Z-normalized within all the ‘steps’ (EXPRESSO-MIBI samples:−40 to +20 pixels; MIBI sample:−10 to +5 pixels), then plotted with R function heatmap.2( ). The line indicating the maximum value for each channel was found by R function max( ).

Data Visualization: Single channel and multi-color images were assembled with ImageJ. Scale bars of ExPRESSO samples were based on instrumental FOV size, then back calculated with the 3.7-fold expansion magnification to indicate pre-expansion dimensions. Visualizations of the analysis results were either produced using Excel, or R packages ‘ggplot2’ and ‘pheatmap’.

### Results

### Development and Evaluation of ExPRESSO Hydrogels

To enable high-dimensional immunohistochemistry on archival tissues samples with MSI, it is necessary to develop an ExM approach compatible with the highly crosslinked nature of FFPE tissue sections which retains tissue structure and protein epitopes for high-plex antibody staining. In addition, the expanded hydrogels must be dehydrated while retaining their expanded nature to allow vacuum-compatibility. Overcoming these challenges would enable high-plex spatial proteomics at unprecedented resolutions on platforms such as MIBI and IMC without instrumental modifications.

In the previously reported expansion Pathology (ExPath) frameworks to enable ExM on FFPE sections (Zhao et al., 2017), the sections are first stained for target proteins in situ before the introduction of monomeric gel components, followed by gelation, proteolytic digestion, and gel expansion (FIG. 6A, top). The ExPRESSO process entails initial sample gelation, a non-enzymatic denaturation, antibody staining, and gel expansion (FIG. 6A, bottom). The enzymatic digestion steps used in the ExPath approaches can result in proteolytic fragmentation and dilution of labels. The avoidance of enzymatic digestion maintains 1) extracellular tissue structures, 2) protein epitope integrity, and 3) antibody signal intensity.

Given the highly cross-linked nature of FFPE tissues, a long heat-induced epitope retrieval (HIER) step was used to reverse these crosslinks, followed by an optimized anchoring protocol for isometric expansion of these tissues without proteolytic digestion (FIG. 6A, bottom). Various cancer tissue types retained tissue structure and epitope staining after this treatment as shown using a duplex immunohistochemistry staining against Vimentin and pan-Cytokeratin (FIG. 6B).

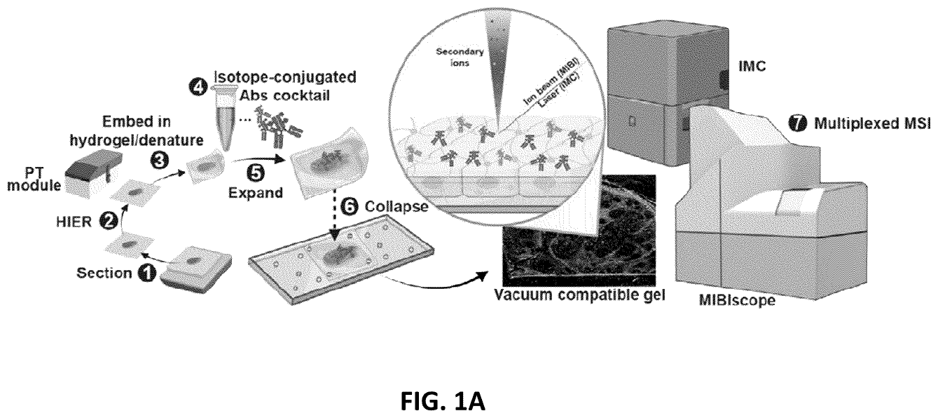

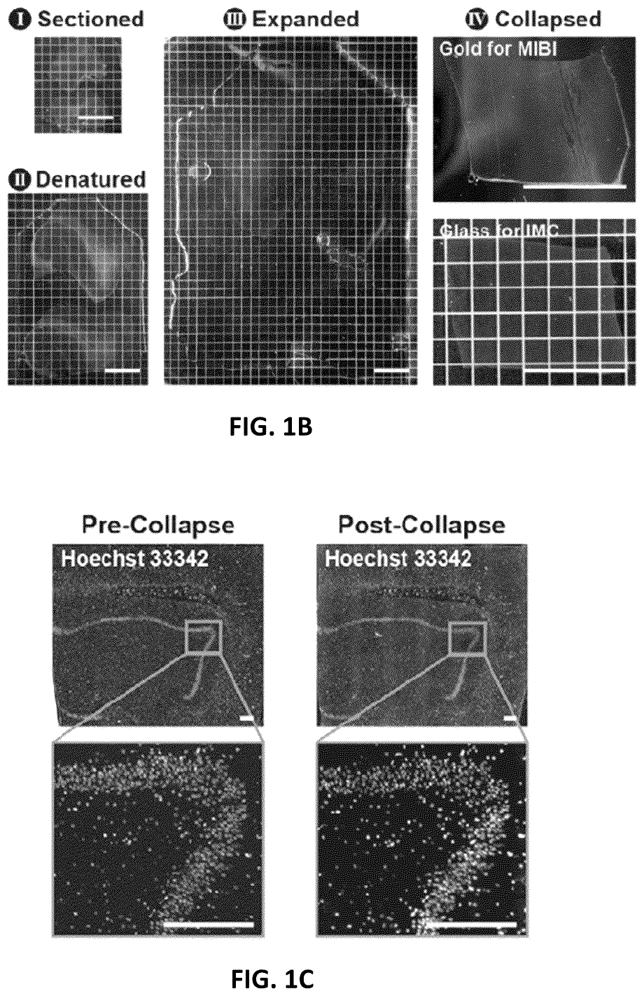

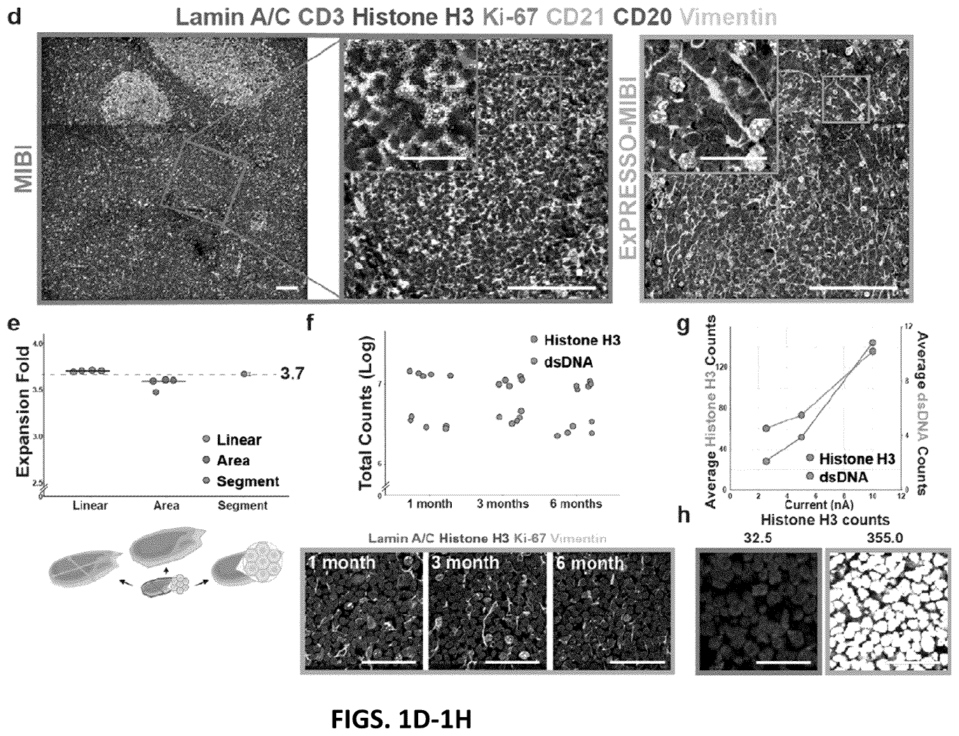

A major challenge of using hydrogel-embedded tissue with imaging platforms, such as the MIBI and IMC, is the prerequisite for dehydrated or vacuum-compatible samples to avoid ionic interference during imaging (Boxer 2009). Since expanded gels are composed of at least 99% water, increasing the salt concentration (Chen et al., 2016) or typical dehydration processes will cause gel shrinkage or disruption of tissue morphology (FIG. 6C). Adherence of the negatively charged gel onto positively charged slides, followed by controlled dispersal of water from the gel, leads to a controlled compression in the Z-axis while maintaining the expanded X- and Y-axes. In ExPRESSO, this new ExM protocol and subsequent compression approach (FIG. 1a, b) was implemented. The compression of the fully expanded ExPRESSO hydrogels onto charged slides resulted in retention of expanded X and Y dimensions, with no observable differences from the pre-compression gel (FIG. 1c).

Since water is completely evacuated from ExPRESSO gels, they retain their shape and show a flat topology even under high vacuum without detachment or bubbling (Figure S1d). High secondary electron counts were obtained from the ExPRESSO gel before and after MIBI ion beam rasterization (FIG. 6D), demonstrating ExPRESSO gels retained similar levels of conductivity like unexpanded tissue sections. Conventional MIBI and ExPRESSO-MIBI imaging on adjacent tonsil sections were compared under identical instrument conditions. ExPRESSO-MIBI imaging resulted in a notable improvement in the spatial resolutions with no loss of architecture of a B cell follicle (FIG. 1d). Measurements with a profilometer indicated that the compressed ExPRESSO gel was approximately 780 nm thick (FIG. 6E). The high axial resolution of the MIBI also allowed depth profiling of the ExPRESSO tissues (FIG. 6F), enabling future opportunities in 3D reconstruction of archival samples.

Three strategies were implemented to determine the extent of lateral expansion in ExPRESSO methodology (FIG. 1e). Linear dimension measurements of the pre- and post-ExPRESSO tissues, area calculations of tissue space occupied pre- and post-ExPRESSO and cell size distribution based on cell segmentation of original and post-ExPRESSO tonsil images were concordant and indicate that the lateral expansion of ExPRESSO is approximately 3.7-fold (FIG. 1e).

A benefit of the lanthanide tags used for CyTOF, IMC, and MIBI is that these elemental probes are stable for long periods. When stored appropriately in a vacuum desiccator, ExPRESSO tissues stained with lanthanide-tagged antibodies were re-imageable even after 6 months, with relatively consistent signal (FIG. 1f). These results highlight the versatility and potential of ExPRESSO in applications related to spatial analysis of the cellular and biomolecular composition of tissue samples.

There was a proportional relationship between ion dose from the primary beam and secondary ions detected on ExPRESSO gels analyzed by MIBI (FIG. 1g), in line with previous observations in MIBI samples (Keren 2019). The possibility of increasing the beam current by four-fold to 10 nA for ExPRESSO sample acquisition was tested and a comparable resolution as the one obtained in unexpanded samples imaged at 2.5 nA was achieved (FIG. 6G). Matching imaging resolution in this manner effectively resulted in more than 4-fold increase in detected ion counts on ExPRESSO samples, with the same imaging time and effective resolution (FIG. 1h). These data indicate the flexibility for ExPRESSO to obtain higher signal counts at the same resolutions and acquisition rates used in a typical MIBI experiment. Conversely, imaging speed can be substantially accelerated during ExPRESSO imaging to achieve resolutions and signal counts comparable to unexpanded samples. Together, these results demonstrate improvements in MSI-based spatial proteomic imaging resolutions, speed, and signal yield enabled by ExPRESSO gels.

### ExPRESSO Enables Mass Spectrometry Imaging at Unparalleled Resolution

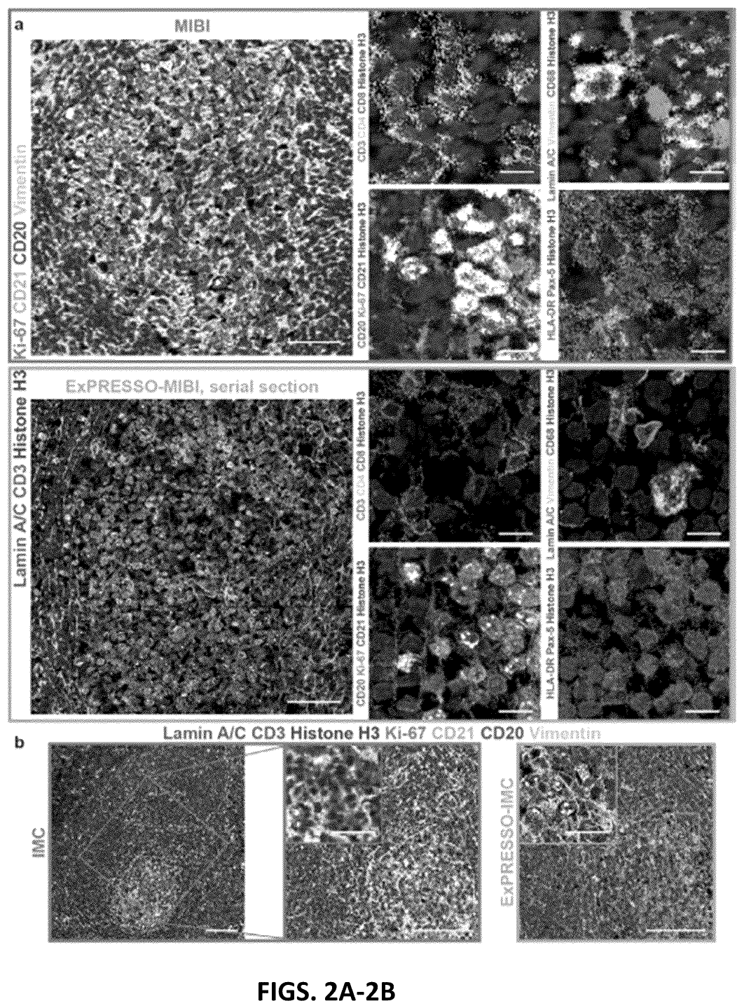

The multiplexed capabilities of the MIBI were leveraged to evaluate epitope retention of tissues between conventional staining and ExPRESSO-treatment on adjacent human tonsil sections. Samples were stained with 20 key lineage-specific and tissue structural markers (FIG. 2A). There was consistent staining and tissue distribution patterns between these conditions, and notable improved resolution in the ExPRESSO-treated sections. It is noted the T cell markers CD3, CD4 and CD8 show clear non-overlapping CD4 and CD8 expression (FIG. 2a), while CD20, Ki-67 and CD21 were appropriately found within the B cell follicles (FIG. 2a). Additionally observed were the distinctive CD68 expression on macrophages, structural markers Vimentin and Lamin A/C, and the enrichment of HLA-DR and Pax-5 within B cell follicles (FIG. 2a). Similar improvements of applying ExPRESSO on the IMC platform were seen (FIG. 2b), demonstrating the consistency and versatility of our method.

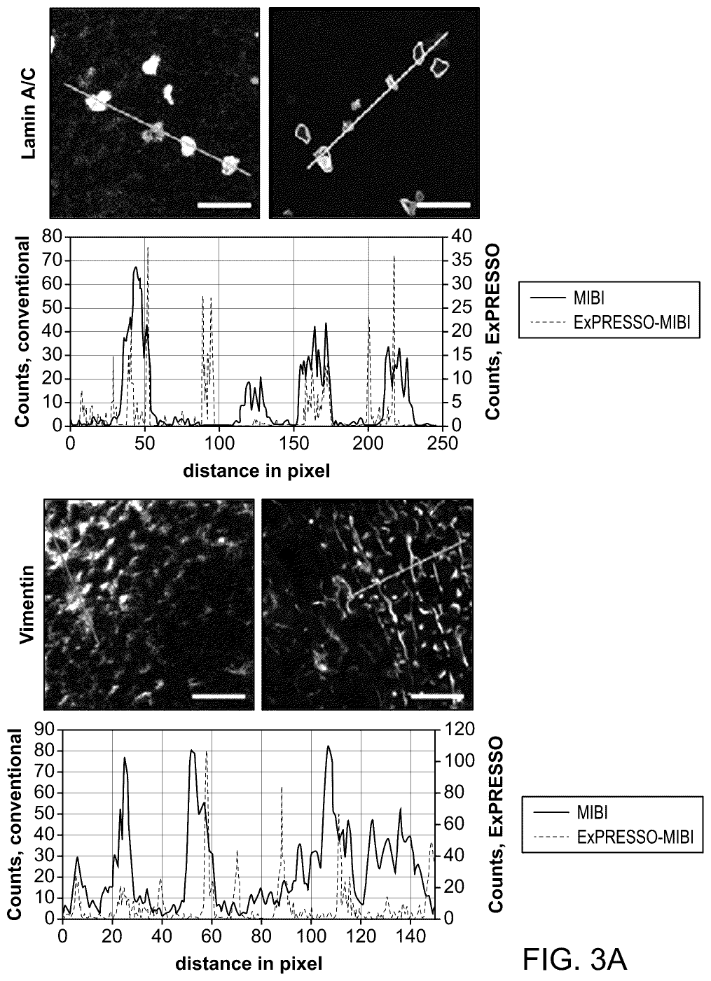

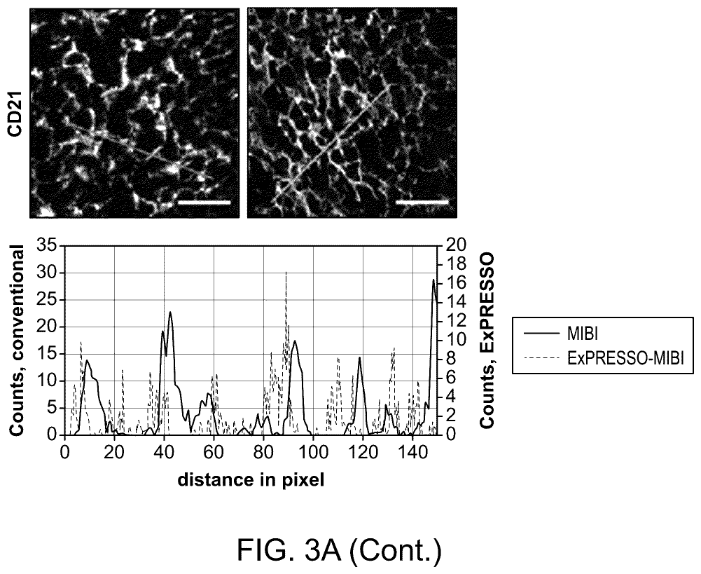

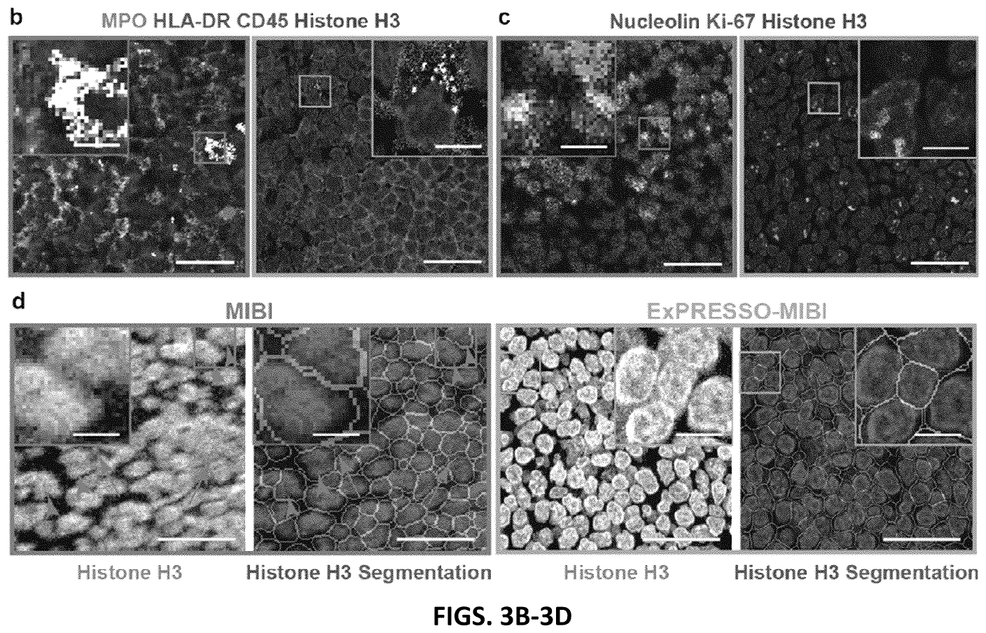

Line-scan quantifications of unexpanded and ExPRESSO-treated sections in MIBI and IMC images confirmed that ExPRESSO resulted in enhanced ability to distinguish between cell and tissue structures, such as Lamin A/C, Vimentin, CD21, and Histone H3 (FIGS. 3a). There was an unexpected improvement in the signal-to-noise ratio, likely due to the clearance of tissue lipids and extracellular matrix during the denaturation process (FIG. 3a). The increased resolution revealed structures previously unresolvable using the MIBI or IMC, including MPO granules, Ki-67 speckles, nucleolin puncta, and clusters of H3K9ac epigenetic modifications (FIGS. 3B and C). ExPRESSO also improved cell segmentation performance, as exemplified using a neural network segmentation method, MESMER, for cell feature extraction and quantification (Greenwald et al., 2021) (FIGS. 3d and S3d). Taken together, these experiments demonstrate that ExPRESSO enables high-plex protein profiling in archival tissue samples at enhanced resolutions.

### ExPRESSO Resolves Brain Tissue Features

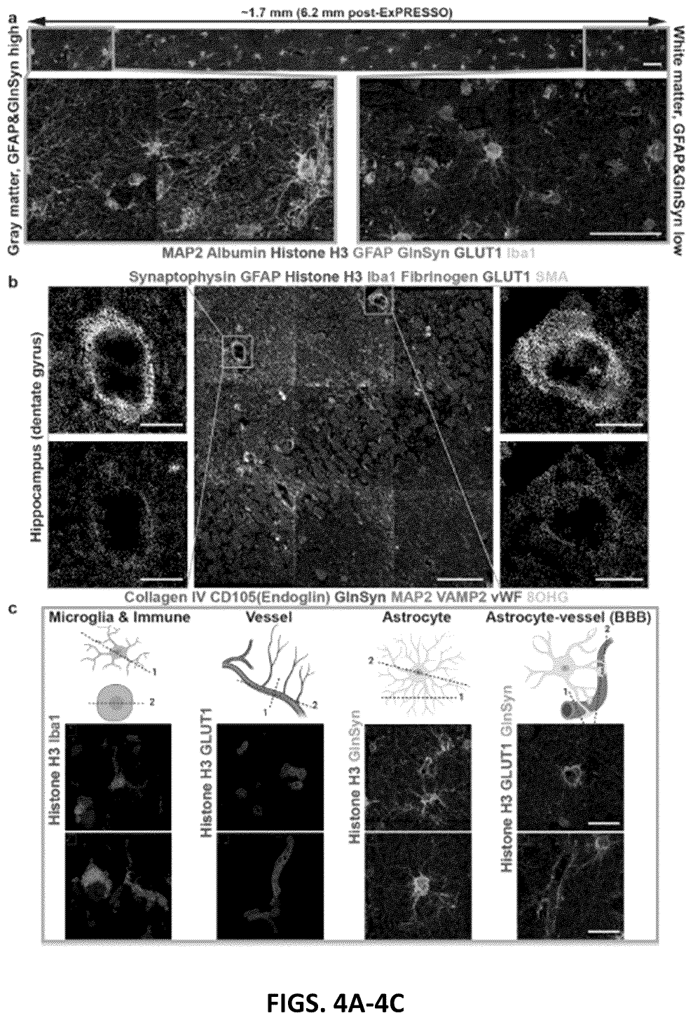

ExPRESSO-MIBI imaging was performed using a panel of 21 markers on archival human brain tissues originating from the middle frontal gyrus and hippocampus. The staining patterns of these antibodies were consistent with Human Protein Atlas (Uhlén 2015) and a recent MIBI brain imaging (Vijayaragavan 2022). Comparable staining patterns between unexpanded and ExPRESSO-treated sections of brain tissues were observed. This further confirmed the retention of protein epitopes in our proteolytic digestion-free method and applicability of ExPRESSO across various tissue types. Notable, typical star-shaped morphology of astrocytes are revealed with Glutamine Synthetase (GlnSyn) and Glial Fibrillary Acidic Protein (GFAP) markers; distinct microglial shapes are seen with Iba1 staining; cortical neurons of the middle frontal gyrus and granule cells of the hippocampus are seen through markers such as MAP2 or CD56; and vasculature are demarcated by GLUT1, CD105 (Endoglin) and SMA (FIGS. 4A and B).

MIBI was used to image a strip of ExPRESSO-treated middle frontal gyrus tissue, traversing from gray to white matter (FIGS. 4a). Visual and quantitative analysis of markers that are differentially expressed between the gray and white matter confirmed their expected patterns (FIG. 4A; gray matter: GFAP and GlnSyn high; white matter: GFAP and GlnSyn low). An improvement in resolving cells and features around the BBB (FIG. 4b) was observed. Landmark cell types and features in the brain were identified, including microglia (Iba1+), vasculature (GLUT1+), astrocytes (GlnSyn+) and the contacts between astrocytic end-feet and endothelial cells around the BBB (GLUT1+ and GlnSyn+) (FIG. 4c). ExPRESSO-IMC also demonstrated similar capabilities to identify and resolve fine brain cytoarchitecture.

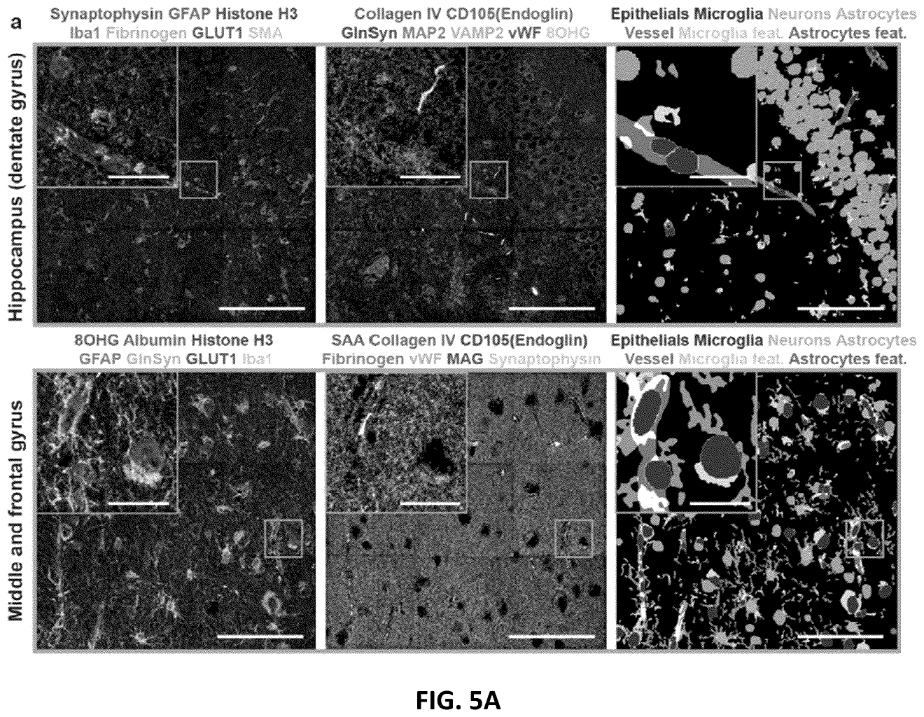

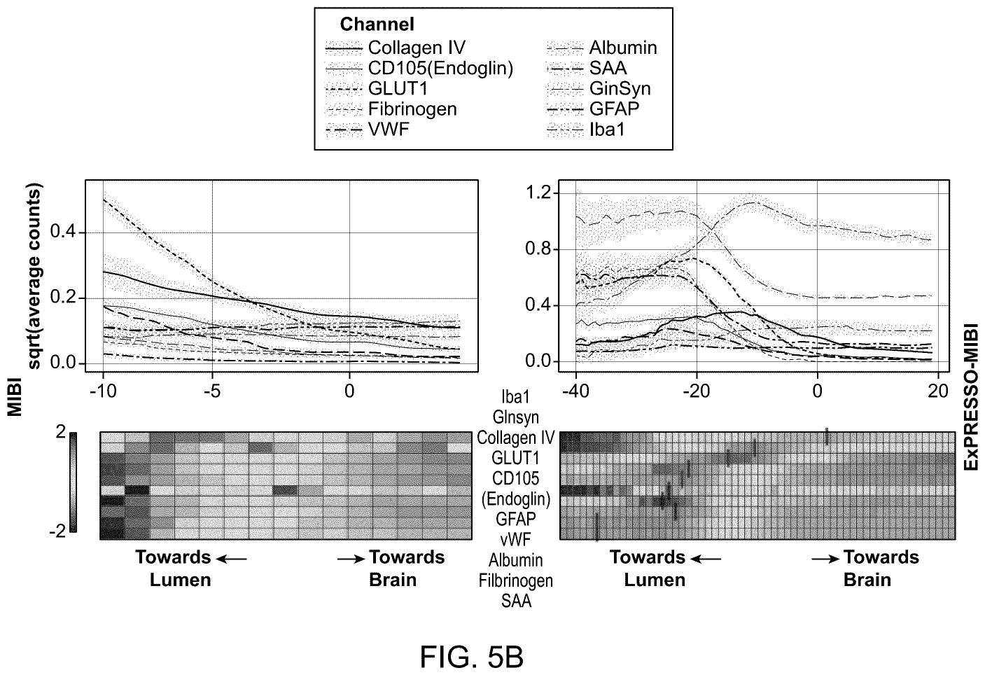

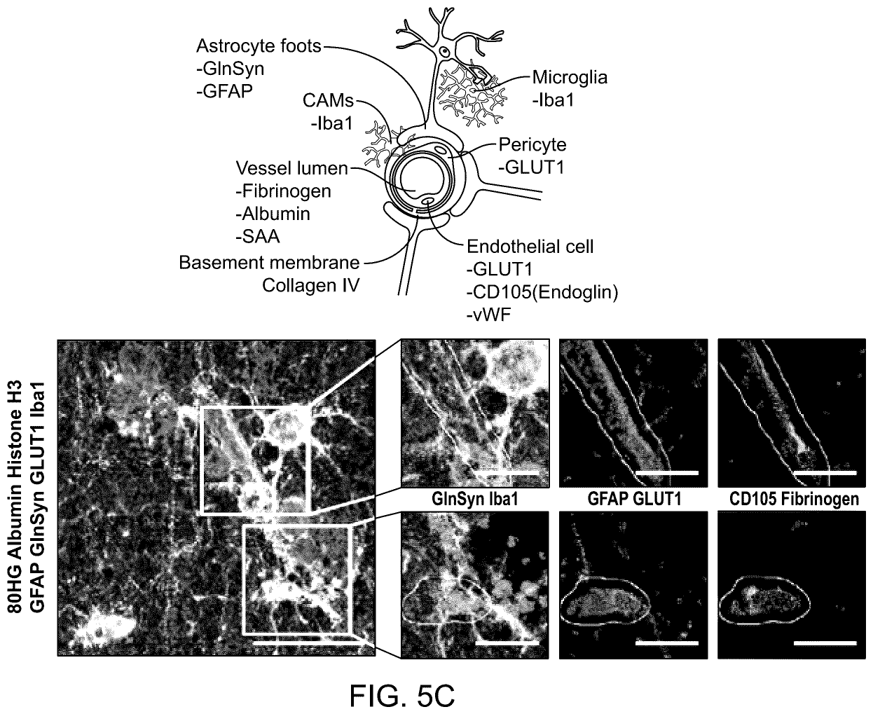

Although deep learning-based nuclear segmentation is generally used for high-dimensional tissue imaging analysis (Greenwald et al., 2021, Yurys 2018 cell, Christian 2020, Keren 2018, Jiang 2021, Rovira Clave 2021b), this approach is not suitable for the identification of larger brain structures and features. A different approach was used to identify tissue-level features at scale (Material and Methods), thus incorporating both single-cell data and non-nuclear feature-level information. Using this two-pronged approach, intricate brain structures were distinguished while retaining cellular identity, including separating out epithelial, microglial, neuronal cells and astrocytes from blood vessel features, microglia features and astrocyte features (FIG. 5a).

### ExPRESSO Allows Blood Brain Barrier Feature Determinations

The next steps were focused on resolving the complex organization of the BBB. The BBB is a barrier of endothelial cells that selectively allows the passage of ions, macromolecules, and cells. It was postulated that an agglomerated analysis of all ExPRESSO-MIBI BBB structures with our single-cell and non-nuclear feature-level combinatorial analytical approach would allow a reconstruction of the molecular organization at the BBB interface. This computational approach simulates a “walk” from identified endothelial features “outward” away from the vasculature or “inward” toward the lumen of the vessels.

In unexpanded MIBI multiplexed images of BBB structures in a brain sample from a patient diagnosed with Alzheimer's disease (AD), it was not possible to computationally (FIG. 5b, left) or visually discern BBB organization. Analysis of ExPRESSO-MIBI resolved BBB structures (n=103) across 50 field of views (FOVs) revealed a clear, structured ordering of proteins involved in BBB organization (FIG. 5b, right). Notably, the expected presence of Serum Amyloid A (SAA), Fibrinogen, and Albumin originating near the lumen of the BBB was observed, but interesting traversing across the BBB toward the brain (FIG. 5b, right). These factors generally do not traverse beyond the BBB from within the vessels in healthy brain (Nadal 1995, Petersen 2018, Takata 2021), thus indicative of a loss in BBB barrier integrity.

von Willebrand Factor (vWF), a glycoprotein synthesized within endothelial cells and a key regulator of hemostasis (Sadler 1998), was observed outside the lumenal (FIG. 5b, right). A tight enrichment of GFAP, CD105 and GLUT1 was observed beyond the region enriched in vWF (FIG. 5b, right). CD105 and GLUT1 can frequently be found on the surface of blood vessels (Cornford 1993, Rossi 2019), whereas GFAP, a filamentous protein classically used to identify astrocytes, recapitulates the localization of astrocyte end-feet between neurons and blood vessels to mediate neurovascular coupling and signal relay (Mac Vicar 2015) (FIG. 5b, right). Type IV collagen is often found in the vascular basement membrane, which separates the endothelial cells from neurons; it was appropriately detected in this region (FIG. 5b, right). The proximity of astrocytes to the BBB was also demonstrated by the presence of GlnSyn (FIG. 5b, right), a key protective enzyme enriched in astrocytes to protect it against neuronal excitotoxicity (Suárez 2002). Lastly, Iba1 localization reflective of the presence of microglia near BBBs (FIG. 5b, right) was detected. This is a key indicator of their important perivascular localization in sampling the influx of blood-borne agents into the central nervous system via the BBB (Nimmerjahn 2005) (FIG. 5b, right). This analysis demonstrates that ExPRESSO-MIBI and computational approaches can be used to resolve the organization of the BBB within the native tissue context.

ExPRESSO is a method that enables the analysis of expanded samples using methods that that were unable to accommodate hydrated samples. The ExPRESSO framework first expands tissue sections by, e.g., approximately 3.7-fold, followed by antibody cocktail staining, and a final controlled hydrogel compression in the Z-axis for complete water removal. This allows for previously unattainable spatial resolutions and high signal-to-noise sample analysis, using commercially available mass spectrometry-based high-plex tissue imaging instruments without cost-prohibitive and challenging engineering modifications. The compatibility of this method with archival FFPE tissues while maintaining antigenicity will be a key step towards leveraging the large clinical cohorts. ExPRESSO was applied to a panel of 20 markers to human tonsils, reproducing tissue staining patterns performed in parallel on unexpanded samples with approximately 3.7-fold magnification, revealing cellular features previously unresolvable by MIBI and IMC. Next, ExPRESSO was applied to brain samples, a notoriously challenging tissue to image due to high tissue autofluorescence (Jun et al., 2017) and intricate cell and tissue morphologies. It has been demonstrated that ExPRESSO could resolve cellular features in human brain samples, such as the characteristic morphologies of astrocytes, neurons, microglia and blood vessels. This allowed for previously unattainable increases in resolution and measurable features that revealed intricate structure within the BBB. Such quantitative imaging and assessments at high-dimensions and resolutions in situ within biological samples will continue to advance our understanding of tissue biology.

A key limitation of many expansion microscopy-derived methods is the necessary protease digestion step (Chen et al., 2015; Tillberg et al., 2016; Zhao et al., 2017). The ExPRESSO workflow does not include a proteolytic treatment. Instead, a prolonged reverse crosslinking step, optimized anchoring step, and a detergent-based denaturation step was employed to maximize epitope retention while retaining isotropic hydrogel expansion. The initial ExPRESSO screen showed a >80% success rate (40 antibodies out of 49) using FFPE antibody clones routinely used in highly-multiplex tissue imaging studies by our laboratories and others (Keren 2018, Schurch 2020, Ji 2020, Jiang 2021, Phillips 2021, Phillips 2021, Bai 2021, Rovira-Clavé 2021, Vijayaragavan 2022). Although this study focused on the proteome, interrogation of other molecular species, including nucleic acids (Jiang et al., 2021; Schulz et al., 2018), lipids (Götz et al., 2020), glycans (Sun et al., 2021b), drugs (Rovira-Clavé et al., 2021a), and other small molecules (Sun et al., 2021a) will be possible in ExPRESSO-processed tissue samples.

In this study, a monomer solution of acrylamide and sodium acrylate was used at a ratio that limits magnification to about 3.7-fold. Modifications to this ratio by monomer chemistry (Damstra et al., 2021; Truckenbrodt et al., 2018, 2019) and the application of iterative approaches using cleavable monomers (Chang et al., 2017) could potentially to greater lateral resolutions. Improvements in resolution might also be attained with refinements and developments in instrument capabilities. In these experiments, oxygen and xenon ion sources for tissue imaging on the MIBI were leveraged at a resolution of about 400 nm (Keren et al., 2019) and a laser with a spot size of approximately 1000 nm on the IMC (Giesen et al., 2014). protein imaging at a resolution down to 50 nm in single cells using a cesium ion source (Rovira-Clavé et al., 2021a) as been demonstrated. Similarly, a radio frequency plasma oxygen primary ion source has also achieved resolutions down to 40 nm (Malherbe et al., 2016). Such instrumental capabilities, combined with ExPRESSO, will enable antibody barcoding for single-molecule detection and interrogation of an exponentially larger number of targets. Although the collapsing step allows the ExPRESSO gels to withstand high-vacuum environments with an apparent sacrifice of axial resolution, MIBI and many other analytical methods have superior axial resolution over lateral resolutions with the 5 to 100 nm range (Rovira-Clavé et al., 2021a, keren sci ad 2019), allowing it to recapture axial resolutions, opening the way to 3D depth profiling in thick tissue sections.

In summary, ExPRESSO enables analyses of expanded samples with mass spectroscopy-based methods in unprecedented spatial resolutions and dimensions, allowing the interrogation of cells and features at a subcellular resolution while maintaining their native tissue context. ExPRESSO is applicable to a range of biological samples and can potentially reveal fundamental principles of cellular and tissue organization in both health and disease from the molecular scale on up.

### REFERENCES

Alon, S., Goodwin, D. R., Sinha, A., Wassie, A. T., Chen, F., Daugharthy, E. R., Bando, Y., Kajita, A., Xue, A. G., Marrett, K., et al. (2021). Expansion sequencing: Spatially precise in situ transcriptomics in intact biological systems. Science 371.
Angelo, M., Bendall, S. C., Finck, R., Hale, M. B., Hitzman, C., Borowsky, A. D., Levenson, R. M., Lowe, J. B., Liu, S. D., Zhao, S., et al. (2014). Multiplexed ion beam imaging of human breast tumors. Nat Med 20, 436-442.
Bai, Y., Zhu, B., Rovira-Clave, X., Chen, H., Markovic, M., Chan, C. N., Su, T.-H., McIlwain, D. R., Estes, J. D., Keren, L., et al. (2021). Adjacent Cell Marker Lateral Spillover Compensation and Reinforcement for Multiplexed Images. Front Immunol 12, 652631.
Baranski, A., Milo, I., Greenbaum, S., Oliveria, J.-P., Mrdjen, D., Angelo, M., and Keren, L. (2021). MAUI (MBI Analysis User Interface)—An image processing pipeline for Multiplexed Mass Based Imaging. Plos Comput Biol 17, e1008887.
Berman, E. S. F., Fortson, S. L., Checchi, K. D., Wu, L., Felton, J. S., Wu, K. J. J., and Kulp, K. S. (2008). Preparation of single cells for imaging/profiling mass spectrometry. J Am Soc Mass Spectr 19, 1230-1236.
Berry, K. A. Z., Hankin, J. A., Barkley, R. M., Spraggins, J. M., Caprioli, R. M., and Murphy, R. C. (2011). MALDI Imaging of Lipid Biochemistry in Tissues by Mass Spectrometry. Chem Rev 111, 6491-6512.
Chang, J.-B., Chen, F., Yoon, Y.-G., Jung, E. E., Babcock, H., Kang, J. S., Asano, S., Suk, H.-J., Pak, N., Tillberg, P. W., et al. (2017). Iterative expansion microscopy. Nat Methods 14, 593-599.
Chen, F., Tillberg, P. W., and Boyden, E. S. (2015). Expansion microscopy. Science 347, 543-548.
Damstra, H. G., Mohar, B., Eddison, M., Akhmanova, A., Kapitein, L. C., and Tillberg, P. W. (2022). Visualizing cellular and tissue ultrastructure using Ten-fold Robust Expansion Microscopy (TREx). Elife 11.
Damstra, H. G. J., Mohar, B., Eddison, M., Akhmanova, A., Kapitein, L. C., and Tillberg, P. W. (2021). Visualizing cellular and tissue ultrastructure using Ten-fold Robust Expansion Microscopy (TREx). Biorxiv 2021.02.03.428837.
Gambarotto, D., Zwettler, F. U., Guennec, M. L., Schmidt-Cernohorska, M., Fortun, D., Borgers, S., Heine, J., Schloetel, J.-G., Reuss, M., Unser, M., et al. (2019). Imaging cellular ultrastructures using expansion microscopy (U-ExM). Nat Methods 16, 71-74.
Gassen, S. V., Callebaut, B., Helden, M. J. V., Lambrecht, B. N., Demeester, P., Dhaene, T., and Saeys, Y. (2015). FlowSOM: Using self-organizing maps for visualization and interpretation of cytometry data. Cytom Part A 87, 636-645.
Giesen, C., Wang, H. A. O., Schapiro, D., Zivanovic, N., Jacobs, A., Hattendorf, B., Schüffler, P. J., Grolimund, D., Buhmann, J. M., Brandt, S., et al. (2014). Highly multiplexed imaging of tumor tissues with subcellular resolution by mass cytometry. Nat Methods 11, 417-422.
Goltsev, Y., Samusik, N., Kennedy-Darling, J., Bhate, S., Hale, M., Vazquez, G., Black, S., and Nolan, G. P. (2018). Deep Profiling of Mouse Splenic Architecture with CODEX Multiplexed Imaging. Cell 174, 968-981.e15.
Götz, R., Kunz, T. C., Fink, J., Solger, F., Schlegel, J., Seibel, J., Kozjak-Pavlovic, V., Rudel, T., and Sauer, M. (2020). Nanoscale imaging of bacterial infections by sphingolipid expansion microscopy. Nat Commun 11, 6173.
Greenwald, N. F., Miller, G., Moen, E., Kong, A., Kagel, A., Dougherty, T., Fullaway, C. C., McIntosh, B. J., Leow, K. X., Schwartz, M. S., et al. (2021). Whole-cell segmentation of tissue images with human-level performance using large-scale data annotation and deep learning. Nat Biotechnol 1-11.
Han, G., Spitzer, M. H., Bendall, S. C., Fantl, W. J., and Nolan, G. P. (2018). Metal-isotope-tagged monoclonal antibodies for high-dimensional mass cytometry. Nat Protoc 13, 2121-2148.
Ji, A. L., Rubin, A. J., Thrane, K., Jiang, S., Reynolds, D. L., Meyers, R. M., Guo, M. G., George, B. M., Mollbrink, A., Bergenstråhle, J., et al. (2020). Multimodal analysis of composition and spatial architecture in human squamous cell carcinoma. Cell 182, 497-514.
Jiang, S., Chan, C. N., Rovira-Clave, X., Chen, H., Bai, Y., Zhu, B., McCaffrey, E., Greenwald, N. F., Liu, C., Barlow, G. L., et al. (2021). Virus-Dependent Immune Conditioning of Tissue Microenvironments. Biorxiv 2021.05.21.444548.
Jun, Y. W., Kim, H. R., Reo, Y. J., Dai, M., and Ahn, K. H. (2017). Addressing the autofluorescence issue in deep tissue imaging by two-photon microscopy: the significance of far-red emitting dyest† †Electronic supplementary information (ESI) available: Materials and procedures regarding the synthesis of all of the dyes, photophysical properties and tissue and cell imaging. See DOI: 10.1039/c7sc03362a. Chem Sci 8, 7696-7704.
Keren, L., Bosse, M., Marquez, D., Angoshtari, R., Jain, S., Varma, S., Yang, S.-R., Kurian, A., Valen, D. V., West, R., et al. (2018). A Structured Tumor-Immune Microenvironment in Triple Negative Breast Cancer Revealed by Multiplexed Ion Beam Imaging. Cell 174, 1373-1387.e19.
Keren, L., Bosse, M., Thompson, S., Risom, T., Vijayaragavan, K., McCaffrey, E., Marquez, D., Angoshtari, R., Greenwald, N. F., Fienberg, H., et al. (2019). MIBI-TOF: A multiplexed imaging platform relates cellular phenotypes and tissue structure. Sci Adv 5, eaax5851.
Ku, T., Swaney, J., Park, J.-Y., Albanese, A., Murray, E., Cho, J. H., Park, Y.-G.,
Mangena, V., Chen, J., and Chung, K. (2016). Multiplexed and scalable super-resolution imaging of three-dimensional protein localization in size-adjustable tissues. Nat Biotechnol 34, 973-981.
Laporte, M. H., Klena, N., Hamel, V., and Guichard, P. (2022). Visualizing the native cellular organization by coupling cryofixation with expansion microscopy (Cryo-ExM). Nat Methods 19, 216-222.
Lin, J.-R., Fallahi-Sichani, M., and Sorger, P. K. (2015). Highly multiplexed imaging of single cells using a high-throughput cyclic immunofluorescence method. Nat Commun 6, 8390.
Malherbe, J., Penen, F., Isaure, M.-P., Frank, J., Hause, G., Dobritzsch, D., Gontier, E., Horréard, F., Hillion, F., and Schaumlöffel, D. (2016). A New Radio Frequency Plasma Oxygen Primary Ion Source on Nano Secondary Ion Mass Spectrometry for Improved Lateral Resolution and Detection of Electropositive Elements at Single Cell Level. Anal Chem 88, 7130-7136.
Phillips, D., Matusiak, M., Gutierrez, B. R., Bhate, S. S., Barlow, G. L., Jiang, S., Demeter, J., Smythe, K. S., Pierce, R. H., Fling, S. P., et al. (2021a). Immune cell topography predicts response to PD-1 blockade in cutaneous T cell lymphoma. Nat Commun 12, 6726.
Phillips, D., Schurch, C. M., Khodadoust, M. S., Kim, Y. H., Nolan, G. P., and Jiang, S. (2021b). Highly Multiplexed Phenotyping of Immunoregulatory Proteins in the Tumor Microenvironment by CODEX Tissue Imaging. Front Immunol 12, 687673.
Rovira-Clavé, X., Jiang, S., Bai, Y., Zhu, B., Barlow, G., Bhate, S., Coskun, A. F., Han, G., Ho, C.-M. K., Hitzman, C., et al. (2021a). Subcellular localization of biomolecules and drug distribution by high-definition ion beam imaging. Nat Commun 12, 4628.
Rovira-Clavé, X., Drainas, A. P., Jiang, S., Bai, Y., Baron, M., Zhu, B., Markovic, M., Coles, G. L., Bassik, M. C., Sage, J., et al. (2021b). Spatial epitope barcoding reveals subclonal tumor patch behaviors. Biorxiv 2021.06.29.449991.
Schulz, D., Zanotelli, V. R. T., Fischer, J. R., Schapiro, D., Engler, S., Lun, X.-K., Jackson, H. W., and Bodenmiller, B. (2018). Simultaneous Multiplexed Imaging of mRNA and Proteins with Subcellular Resolution in Breast Cancer Tissue Samples by Mass Cytometry. Cell Syst 6, 25-36.e5.
Schürch, C. M., Bhate, S. S., Barlow, G. L., Phillips, D. J., Noti, L., Zlobec, I., Chu, P., Black, S., Demeter, J., Mcllwain, D. R., et al. (2020). Coordinated Cellular Neighborhoods Orchestrate Antitumoral Immunity at the Colorectal Cancer Invasive Front. Cell 182, 1341-1359.e19.
Steinhauser, M. L., Bailey, A., Senyo, S. E., Guillermier, C., Perlstein, T. S., Gould, A. P., Lee, R. T., and Lechene, C. P. (2012). Multi-isotope imaging mass spectrometry quantifies stem cell division and metabolism. Nature 481, 516-519.
Stevie, F. (2015). Secondary ion mass spectrometry: applications for depth profiling and surface characterization (New York: Momentum Press).
Sun, D., Fan, X., Shi, Y., Zhang, H., Huang, Z., Cheng, B., Tang, Q., Li, W., Zhu, Y., Bai, J., et al. (2021a). Click-ExM enables expansion microscopy for all biomolecules. Nat Methods 18, 107-113.
Sun, R. C., Young, L. E. A., Bruntz, R. C., Markussen, K. H., Zhou, Z., Conroy, L. R., Hawkinson, T. R., Clarke, H. A., Stanback, A. E., Macedo, J. K. A., et al. (2021b). Brain glycogen serves as a critical glucosamine cache required for protein glycosylation. Cell Metab 33, 1404-1417.e9.
Tillberg, P. W., and Chen, F. (2019). Expansion Microscopy: Scalable and Convenient Super-Resolution Microscopy. Annu Rev Cell Dev Bi 35, 1-19.
Tillberg, P. W., Chen, F., Piatkevich, K. D., Zhao, Y., Yu, C.-C. (Jay), English, B. P., Gao, L., Martorell, A., Suk, H.-J., Yoshida, F., et al. (2016). Protein-retention expansion microscopy of cells and tissues labeled using standard fluorescent proteins and antibodies. Nat Biotechnol 34, 987-992.
Truckenbrodt, S., Maidorn, M., Crzan, D., Wildhagen, H., Kabatas, S., and Rizzoli, S. O. (2018). X10 expansion microscopy enables 25-nm resolution on conventional microscopes. Embo Rep 19, e45836.
Truckenbrodt, S., Sommer, C., Rizzoli, S. O., and Danzl, J. G. (2019). A practical guide to optimization in X10 expansion microscopy. Nat Protoc 14, 832-863.
Valen, D. A. V., Kudo, T., Lane, K. M., Macklin, D. N., Quach, N. T., DeFelice, M. M., Maayan, I., Tanouchi, Y., Ashley, E. A., and Covert, M. W. (2016). Deep Learning Automates the Quantitative Analysis of Individual Cells in Live-Cell Imaging Experiments. Plos Comput Biol 12, e1005177.
Zhao, Y., Bucur, O., Irshad, H., Chen, F., Weins, A., Stancu, A. L., Oh, E.-Y., DiStasio, M., Torous, V., Glass, B., et al. (2017). Nanoscale imaging of clinical specimens using pathology-optimized expansion microscopy. Nat Biotechnol 35, 757-764.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method for processing a tissue sample, comprising:
(a) permeating the tissue sample with monomers for a negatively charged expandible gel;
(b) allowing the monomers to polymerize in the tissue sample;
(c) hydrating the tissue sample, thereby causing the sample to expand;
(d) adhering expanded tissue sample to a positively charged surface; and
(e) dehydrating the expanded tissue sample while it is on the planar surface.

2. The method of claim 1, wherein step (a) is done by immersing the sample in a solution comprising acrylate, acrylamide and/or N,N′-methylbisacrylamide.

3. The method of claim 2, wherein step (b) is done by exposing the sample to ammonium persulfate (APS) and N,N,N′,N′-tetramethyl ethylenediamine (TEMED) after step (a).

4. The method of claim 1, wherein the hydrating of (c) is done by incubating the sample in an aqueous medium.

5. The method of claim 1, wherein step (d) is done by placing the expanded tissue sample on a planar substrate that that contains a positively charged surface.

6. The method of claim 5, wherein the planar substrate has been silanized.

7. The method of claim 1, wherein step (e) is done in a desiccation chamber.

8. The method of claim 1, wherein the tissue sample is a formalin fixed tissue section and the method further comprises:
before step (a):
(i) treating the tissue section with heat in order to break crosslinks in the section; and
(ii) incubating the tissue section with acrylamide to quench any reactive methylols;
between steps (b) and (c):
(iii) treating the sample with a denaturing agent; and
(iv) staining the tissue section with one or more binding agents; and
after step (e):
(v) analyzing the binding of the one or more binding agents to the tissue section.

9. The method of claim 8, wherein in step (i) the heat treatment is at a temperature of 60° C. for at least 30 mins.

10. The method of claim 8, wherein in step (ii) the tissue section is incubated with at least 20% acrylamide for at least one hour.

11. The method of claim 8, wherein in step (ii) the tissue section is denatured using sodium dodecyl sulfate (SDS).

12. The method of claim 8, wherein the one or more antibodies is an antibody cocktail

13. The method of claim 12, wherein the cocktail contains at least 10 antibodies.

14. The method of claim 13, wherein the antibodies are mass tagged.

15. The method of claim 8, wherein the analysis of (v) comprises expositing the tissue sample to a vacuum conditions.

16. The metho of claim 8, wherein the analysis of (v) is done by multiplexed ion beam imaging (MIBI), imaging mass cytometry (IMC) or co-detection by indexing (CODEX).

17. The method of claim 8, wherein the tissue section is a paraffin embedded section, and the method further comprises de-paraffinizing the tissue section.

18. The method of claim 1, wherein the tissue sample is a section of a human tissue.

19. A composition comprising expanded dehydrated tissue section embedded in a negatively charged gel and mounted on a positively charged planar support.

20. A kit comprising:
monomers for a negatively charged expandible gel;
a substrate that has a positively charged surface;
acrylamide; and
an antibody cocktail.
